(19) United States
(12) Patent Application Publication
(10) Pub. No.: US 2023/0219068 A1
(43) Pub. Date: Jul. 13, 2023

(54) CATALYSTS OR CATALYTIC SYSTEMS COMPRISING LIQUID METALS AND USES THEREOF

(71) Applicant: NewSouth Innovations Pty Limited, Sydney, New South Wales (AU)

(72) Inventors: Junma Tang, Sydney, New South Wales (AU); Zhenbang Cao, Sydney, New South Wales (AU); Torben Jost Daeneke, Melbourne, Victoria (AU); Dorna Esrafilzadeh, Sydney, New South Wales (AU); Kourosh Kalantar-Zadeh, Sydney, New South Wales (AU)

(21) Appl. No.: 17/770,130

(22) PCT Filed: Oct. 21, 2020
(86) PCT No.: PCT/AU2020/051135

§ 371 Date: Apr. 19, 2022

(30) Foreign Application Priority Data
Oct. 21, 2019 (AU) 2019903954

(51) Int. Cl. B01J 23/66; B01J 27/13; B01J 35/12; C01B 32/198; C01B 32/184; C01B 13/02; C01B 3/26; H01M 4/38

(52) U.S. Cl. CPC B01J 23/66; B01J 27/13; B01J 35/12; C01B 32/198; C01B 32/184; C01B 13/0203; C01B 3/26; H01M 4/38; C01B 2203/0277; C01B 2203/1241; C01B 2203/107; C25B 1/02

(57) ABSTRACT

The present invention relates to catalysts or catalytic systems comprising liquid metals, and in particular, to catalysts or catalytic systems comprising liquid metals droplets dispersed in a solvent, as well as to methods and uses of such catalysts or catalytic systems. In some embodiments, the present disclosure provides a ‘green’ carbon capture and conversion technology offering scalability and economic viability for mitigating CO₂ emissions.

This application is a 35 U.S.C. § 371 national phase application of PCT Application PCT/AU2020/051135 filed 21 Oct. 2020, which claims priority from Australian Provisional Patent Application No. 2019903954 filed 21 Oct. 2019, the contents of each of which should be understood to be incorporated.

### FIELD OF THE INVENTION

The present disclosure relates to catalysts or catalytic systems comprising liquid metals, and in particular, to catalysts or catalytic systems comprising liquid metals droplets dispersed in a solvent, as well as to methods and uses of such catalysts or catalytic systems. In some embodiments, the present disclosure provides a ‘green’ carbon capture and conversion technology offering scalability and economic viability for mitigating CO₂ emissions.

In one embodiment, the catalysts or catalytic systems described herein are useful for converting carbon dioxide into solid carbon and molecular oxygen. In another embodiment, the catalysts or catalytic systems described herein are useful for converting methane into solid carbon and molecular hydrogen. In a preferred embodiment, the catalysts or catalytic systems described herein are capture and conversion systems. However, it will be appreciated that the invention is not limited to this particular use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Heterogeneous catalytic systems are extensively used in chemistry and chemical engineering to catalyse a variety of chemical reactions. By far the most common heterogeneous catalytic systems are those that utilise a solid phase catalyst reacted with gas phase reactant(s), but solid phase reactive systems suspended in a liquid phase and liquid-liquid catalytic capture and conversion systems are also known. Conventional heterogeneous catalytic systems based on microcrystallites of transition metals supported on porous supports provide a variety of catalytic sites having diverse electronic properties and coordination environments, and therefore often have a limited selectivity to the desired product and resistance to poisoning and deactivation. However, capture and conversion systems are often easy to separate from the reaction mixtures and therefore recycle, and catalyst contamination of products can be minimised.

By way of alternative, catalytic liquid phase-based systems such as those comprising liquid metals and alloys have been investigated. In these systems, molten metals are used to catalyse reactions including dehydrogenation of alcohols, amines, and hydrocarbons, hydrogenation of hydrocarbons, etc. However, despite having good selectivity and stability, bulk or pool form molten metal catalysts have very small interfacial areas that greatly reduces their effectiveness and requires large reactors for a given conversion. Further, molten metals present problems with handling and corrosion, since high temperatures and harsh conditions are often required.

Attempts to overcome these problems have been made in the prior art and include immobilisation of liquid metals in solid supports. Furthermore, for reactions having one or more solid reaction product(s), supported or heterogeneous solid/gas and solid/liquid catalytic systems are susceptible to solid product(s) covering the reactive surface and blocking access to catalytically active sites and/or cause damage to the active sites. One such reaction includes the reduction of carbon dioxide to solid carbon and molecular oxygen, where “coking” of reactive materials by the solid carbon produced is problematic. Supported materials are disadvantageous as coking occurs rapidly. Carbon-carbon (C—C) bond formation results in solid deposits (such as sheets) of carbon that can coat the surfaces of catalytic sites which terminate the catalytic process. As such, coking can “poison” the catalytic systems.

It is well known that carbon dioxide (CO₂) is a major greenhouse gas principally produced by non-renewable energy generation. The rapid increase of CO₂ emissions has disrupted the global carbon cycle and had a planetary warming impact. Global warming and a changing climate have a range of potential ecological, physical and health impacts, including extreme weather events (such as floods, droughts, storms, and heatwaves); sea-level rise; altered crop growth; and disrupted water systems.

Clean and low-cost sources of energy are important to maintain environmental sustainability. However, greater than 80% of global energy is still currently sourced from fossil fuels, with dire environmental implications as discussed above due to global warming as a result of CO₂ emissions into the atmosphere. Currently, CO₂ conversion into other value-added hydrocarbons through environmental-friendly and cost-effective approaches is of utmost importance. Achieving CO₂ conversion into value-added products with minimal input energy and sustainably remains challenging.

Current carbon capture/storage technology has not been able to capture large amounts of CO₂. For example, amine absorption of CO₂ is the most mature capture technology. However, it is quite a complex process and very energy intensive due to the requirement for cooling and heating. The need to sequester the CO₂ in underground aquifers is also difficult and makes large-scale application of CO₂ amine absorption less attractive.

Mineral carbonation and oxyfuel combustion represent alternative technologies for CO₂ capture that are still in development and not presently cost effective. Another alternative technology is electrocatalytic reduction of CO₂; however, as CO₂ is a remarkably stable molecule, finding electrocatalysts that work under mild conditions (e.g., low overpotential and at ambient temperatures) has proven difficult. Activating CO₂ into CO₂^{⋅-} radicals or other intermediates is a crucial step for CO₂ conversion, while the stability of CO₂ molecules imposes a significant challenge. External energy is often required, and catalytic systems are commonly used to lower the energy barrier for CO₂ reduction. Two dominant approaches have been pursued to date, the first being where CO₂ is reduced in its gaseous form to CO at high temperatures in the presence of, e.g., an oxide catalyst, the second being where dissolved CO₂ is electrocatalytically reduced within a liquid environment to a range of small molecules including CO, C₂H₄, CH₄, HCO₂H and CH₃OH. However, as CO and other small molecules are volatile, potent pollutants themselves, alternative methods for converting carbon dioxide to less harmful products would be desirable. Furthermore, these and other approaches still generally rely on high temperatures and/or pressures, and/or large quantities of organic solvents or corrosive materials.

One alternative is to reduce CO₂ to a solid carbon product. However, as noted above, solid reaction products present numerous problems for commonly used and existing catalytic systems. Indeed, one recent approach to catalysing the reduction of carbon dioxide to solid carbon and molecular oxygen is the use of electrolysed liquid metal catalyst. This process is advantageously effective at room temperature and is resistant to catalyst deactivation by coking of the liquid metal surface. However, this process requires application of electrical current, which is energy intensive and requires complex infrastructure to carry out on an industrial scale. However, catalytic reduction based on electrochemical approaches are typically inefficient and have less surface area for the catalytic sites (low surface to volume ratio).

Additionally, solid metals have been used in CO₂ reduction. However, this approach has poor CO₂ reduction efficiencies, poor selectivity and are unstable.

Light and electricity have been used as alternatives for CO₂ reduction. However, in general, existing electro- or photo-initiated CO₂ reduction suffers from sluggish reaction rates and high energy consumption. For example, the active sites of solid metal catalysts can deteriorate under intense mechanical stimuli and/or can be deactivated when carbonaceous (carbon based) materials adhere onto the catalytic sites during CO₂ reduction.

Current approaches to CO₂ reduction have a number of drawbacks including for example difficulty lowering the energy barrier of CO₂ activation, poor and slow conversion rates of CO₂, poor durability of catalysts due to the coking of active sites, poor selectivity for specific species and poor affinity between catalytic surfaces and CO₂ gas.

Therefore, alternative technologies are required for capturing and converting CO₂ into value-added species, at low input energy, to mitigate the negative effects of CO₂ and support a sustainable carbon cycle.

Accordingly, there is a need in the art for alternative catalytic systems suitable, in particular, for conducting reactions that produce solid reaction products, such as the reduction of carbon dioxide to solid carbon and molecular oxygen.

More generally, there is also a need in the art for catalytic systems that enable conversion of industrially relevant reactions to be performed at ambient or near-ambient conditions, such as room temperature and atmospheric pressure.

Still further, there is a need in the art for catalytic systems having “green” credentials, in that they utilise environmentally benign solvents and/or comprise one or more recyclable components.

It is an object of the present invention to overcome or ameliorate one or more of the disadvantages of the prior art, or at least to provide a useful alternative. It is an object of a preferred embodiment of the present invention to provide a catalytic system suitable for initiating a range of reactions under benign conditions, including those having solid reaction products.

### SUMMARY OF THE INVENTION

According to one aspect of the present invention, there is provided a catalyst or catalytic system comprising liquid metal droplets dispersed in a solvent. Advantageously, the formation of liquid metal droplets provides a higher surface area for reaction. In preferred embodiments, the liquid metal droplets are dispersed in the solvent by application of energy such as mechanical energy. The deposits formed on the surface of the liquid metal droplets as a result of the conversion reaction can be exfoliated or removed by agitation such as providing an energy source (i.e., sonication). This advantageously prevents or ameliorates “poisoning” of the reactive sites such that the functional material (for example, catalyst or catalytic system) is not suffocated. In some embodiments, the liquid metal surface is not polarised which can assist in exfoliation or removal of deposits.

In some embodiments, the liquid metal has a melting point of between 0° C. and 300° C. In some embodiments, the liquid metal comprises one or more metals selected from the group consisting of: mercury, gallium, indium, bismuth, lead, cadmium, mercury and tin. In some embodiments, the catalyst or catalytic system further comprises a co-contributor. In some embodiments, the co-contributor is an intermetallic phase.

In a preferred embodiment, the catalyst or catalytic system is for reduction of carbon dioxide to yield solid carbon and oxygen gas. In another embodiment, the catalyst or catalytic system is for reduction of methane to yield solid carbon and hydrogen gas. In one embodiment, the solvent has a carbon dioxide solubility of between 20 mg/L and 250 g/L at 25° C.

In another aspect of the present invention, there is provided a process for producing a catalyst or catalytic system as described herein, the process comprising: (a) combining a liquid metal with a solvent; and (b) applying energy to the combination of step (a) so as to form and disperse liquid metal droplets in the solvent, thereby forming the catalyst or catalytic system. In some embodiments, the catalyst or catalytic system is a reactive material. In a preferred embodiment, the catalyst or catalytic system is a capture and conversion system. In a preferred embodiment, the energy in step (b) is ultrasound energy. In some embodiments, the process of the present invention further comprises a co-contributor. As discussed herein, to increase the surface-to-volume ratio of the liquid metals, they are agitated by, for example, sonication or placed under high shear forces to provide micro, sub-micro and/or nano droplets.

In yet another aspect of the present invention, there is provided a method for catalysing a chemical reaction, the method comprising: (a) providing a catalyst or catalytic system as described herein; and (b) contacting the catalyst or catalytic system with a reactant.

In a further aspect of the present invention, there is provided a method for capturing and converting at least one reactant, the method comprising: (a) providing a catalyst or catalytic system as described herein; and (b) contacting the catalyst or catalytic system with the at least one reactant.

In a preferred embodiment, the reactant is carbon dioxide and the chemical reaction is reduction of carbon dioxide to yield solid carbon and oxygen gas.

In some embodiments, the contacting of step (ii) is performed at a temperature of between 0 and 300° C. In some embodiments, the contacting of step (ii) is performed at a temperature of between 0 and 200° C. In some embodiments, the contacting of step (ii) is performed at a temperature of between 0 and 100° C.

### BRIEF DESCRIPTION OF THE DRAWINGS

Preferred embodiments of the invention will now be described, by way of example only, with reference to the accompanying drawings in which:

FIG. 1 shows schematics and Raman spectra of solid carbon produced from CO₂ using liquid metal. a-d, Schematic illustrations for the preparation of a suspension of reactive material (a, b) and the CO₂ reduction process using different mechanical energy inputs (c, d). e, Schematic illustration of the formation and detachment of carbon flakes on the surface of Ga droplets in the presence of the solid rods. f-k, Raman spectra of the samples obtained from the reaction mixes of Ga with different silver salts as precursors in solvents such as dimethylformamide (DMF): Gallium droplets and co-contributor of AgF (f, versus time), AgCl (g), AgBr (h), AgI (i), AgOTf (j) and AgNO₃ (k). The D and G bands at 1350 and 1600 cm⁻¹, respectively, emerged after the reactions occur. l, m, Raman spectra of versus times from the surface of mixtures from the 10-times diluted reaction system (Ga and AgF mix) by employing DMF (I) and a combination of DMF+ ethanolamine (ETA) (m) as the reaction solutions. The blue and red curves in f-m are Raman spectra for the samples before and after reaction, respectively.

FIG. 2 shows (a) a scanning electron microscopy (SEM) image of liquid metal droplets (with rods, which are as a result of a co-contributor presence) produced by sonication; and (b) an energy dispersive X-ray spectroscopy (EDS) image of liquid metal droplets produced by sonication; regions of abundant solid carbon products produced by the reduction of carbon dioxide are indicated with arrows.

FIG. 3 (a) depicts a flask containing a catalyst according to the invention comprising liquid metal droplets dispersed in a solvent receiving carbon dioxide gas through a pipette during sonication and (b) a close-up view of the flask.

FIG. 4 shows the Raman spectrum of an emulsion comprising liquid metal particles after catalysing the reduction of carbon dioxide to solid carbon and molecular oxygen over a period of 5 hours and reflects the presence of carbonaceous materials (peaks at 1360 and 1590 cm⁻¹).

FIG. 5 shows (a) SEM and (b) EDS image of carbon flakes produced from CO₂ reduction. (c) confirms presence of gallium, (d) shows presence of carbon and (e) shows presence of nitrogen. The scale bar represents 1 μm. FIG. 3 confirms formation of a large sheet of carbon.

FIG. 6 shows (a) a liquid from the reactor after 5 hours. Carbonaceous sheets remain suspended due to low density and size while liquid metal droplets precipitate. (b) the extracted and dried carbon with traces of liquid metal.

FIG. 7 is a schematic of large-scale CO₂ scrubbing and C—C conversion system with no CO₂ release.

FIG. 8 shows size distribution characterisation. a, The size distribution of the co-contributor Ag_{0.72}Ga_{0.28} rods. b, The size distribution of the Ga particles after probe sonication.

FIG. 9 shows TGA results of the produced carbon materials in different conditions in the 20 mL reactor. The mass of samples acquired from 2.0 mL homogenous reaction solution is 13.59 mg (1.4 g/mL Ga, 0.20 g/mL AgF in DMF solution), 8.33 mg (0.14 g/mL Ga, 0.020 g/mL AgF in DMF solution) and 11.6 mg (0.14 g/mL Ga, 0.020 g/mL AgF in 90% DMF with 10% ETA solution). Based on mass loss from TGA, calculated the produced carbon in the 20 mL reactor per hour.

FIG. 10 shows Raman characterisation. a,b, Raman mapping on the surface of the mixture after 5 hours reaction from the system by employing 1.4 g/mL Ga and 0.20 g/mL AgF as precursors in DMF (cantering at 1600 cm⁻¹). c,d, Raman spectra pointed on the glass substrate and the surface of mixture separately (marked in b). e,f, Raman spectra on the surface of 7.0 g Ga—Ag bimetallic catalysts containing 2.0 wt % (e) and 5.0 wt % (f) Ag, respectively, before and after 5 hours reaction in DMF solution. g,h, Raman spectra on the surface of catalysts containing Ga (1.4 g/mL, g) or AgF (0.20 g/mL, h), respectively, as the catalysts. i,j, Raman spectra on the surface of catalysts before and after 5 hours reaction by using KCl (0.20 g/mL, i) and NaCl (0.20 g/mL, j) as the precursor with Ga (1.4 g/mL) in the DMF system. k, Raman spectra of the mixture before and after pumping CO₂ into the reaction unit for 5 hours with magnetic stirrer as the energy source (using 1.4 g/mL Ga and 0.20 g/mL AgF as precursors). l, Raman spectra of the mixture before and after bubbling N2 into the reaction system for 5 hours (using 1.4 g/mL Ga and 0.20 g/mL AgF). m,n, Raman spectrum of the carbonaceous materials on the surface of catalysts by utilizing 50- or 100-time diluted reaction unit (containing 0.028 g/mL gallium with 0.0040 g/mL AgF or 0.014 g/mL gallium with 0.0020 g/mL AgF, respectively). o,p, Raman spectrum of the carbonaceous product on the surface of mixture with DMSO (o) and water (p), respectively, as the reaction solution (using 0.14 g/mL Ga and 0.020 g/mL AgF as precursors).

FIG. 11 shows GC analysis of the gas products in the 20 mL reactor. Output gas measurements during the reaction using DMF or DMF+ETA as reaction solution for 5 hours. The amount of H₂ decreased sharply and was almost undetectable after 30 hours reaction (in the scaled-up experiments). The generation of H₂ in DMF+ETA case is associated to the contamination in ETA (purity: ˜98%).

FIG. 12 shows characterisation data of the carbonaceous products (a-b) and the demonstration of the scalability of the technology (c-e). a, SEM and EDS images (inserted in a) of the carbonaceous materials. b, Transmission electronic microscopy (TEM) and selected area electron diffraction (SAED) (inserted in b) images of the separated carbonaceous products. c, Conversion efficiencies of CO₂ under different configurations showing the maximum efficiency of 92% for CO₂ capture and conversion in DMF+ETA case. d,e, Schematic representations of the scaled-up reactors for full CO₂ conversion for DMF and DMF+ETA reactors.

FIG. 13 shows characterisation of the carbonaceous materials. a, Elemental ratio of the carbonaceous products from EDS mappings. b,c, FTIR spectrum of the produced solid carbon. d,e, C1s and O1s XPS spectra of the carbonaceous materials. g, HRTEM image of the carbonaceous materials in amorphous state.

FIG. 14 shows photographic images of an embodiment of the set-up for CO₂ capture and conversion. In DMF+ETA case, the height of the reactor is 27 cm for 92% efficiency at the CO₂ flow rate of ˜8 sccm.

FIG. 15 shows GC analysis and TGA curves of the produced carbon in the scaled-up experiments. a, O₂ measurements in the output gas at different time during the reaction using DMF and DMF+ETA as reaction solution. b, TGA curves of the produced carbon. \textcircled{1} The curve of the carbonaceous materials produced in the 40 cm high reactor using DMF as the solvent for 6 h. The mass of the sample from 2.0 mL reaction solution was found to be 8.35 mg. \textcircled{2} The TGA of produced carbon in the 27 cm high reactor using DMF+ETA as the solvent for 30 h. The mass of the sample from 2.0 mL reaction solution was found to be 8.80 mg.

FIG. 16 shows characterisation data of the functional materials. a, XRD patterns after probe sonication by using different silver salts with Ga as the precursors. Except for Ga/AgNO₃, the other silver salts and Ga were converted into Ag_{0.72}Ga_{0.28}. b,c, XPS analysis of the state of silver and fluoride on the surface of the mixtures after probe sonication. d-i, SEM images of the materials after probe sonication when different silver salts were used as precursors as Ga/AgNO₃ (d), Ga/AgOTf (e), Ga/AgBr (f), Ga/AgI (g), Ga/AgCl (h), and Ga/AgF (i). Ag_{0.72}Ga_{0.28} was found in the shape of rods only when AgF was used as the precursor, and some rods were also seen for the AgCl case, while Ag_{0.72}Ga_{0.28} from other silver salts have non-rod morphologies. j,k, TEM and HRTEM of Ag_{0.72}Ga_{0.28} nanorods with SAED images inserted in j. l-q, TEM and corresponding EDS images of Ag_{0.72}Ga_{0.28} rods and Ga droplets.

FIG. 17 shows characterisation of the Ga—Ag alloy samples. a, XRD patterns of \textcircled{1} the gallium particles, bimetallic Ga—Ag alloys containing \textcircled{2} 2.0 wt % and \textcircled{3} 5.0 wt % Ag after probe sonication. The sample with 2.0 wt % Ag has no detectable XRD signal. b, c, SEM images of the Ga—Ag alloys containing \textcircled{2} 2.0 wt % and \textcircled{3} 5.0 wt % Ag, respectively, after probe sonication. No Ag_{0.72}Ga_{0.28} rods were observed in these two samples.

FIG. 18 shows SEM, EDS and XRD data of an embodiment of the catalysts of the present invention. SEM (the left panel), EDS (the middle two panels), and XRD (the right panel) characterisations of an embodiment of the catalysts of the present invention by using different silver salts as precursors after probe sonication.

FIG. 19 shows SEM and EDS micrograph images of Ga/Ag_{0.72}Ga_{0.28} after reaction for 5 hours. a, SEM. b, Mapping of Ga. c, Mapping of Ag. The structure of the Ag_{0.72}Ga_{0.28} rods remains the same morphology after long-term reaction.

FIG. 20 shows concentration of the Ga ions and Ag ions in the reaction solution. a,b, ICP-MS results about the concentration of Ga ions (a) and Ag ions (b) in the reaction system during CO₂ conversion for 5 hours. The samples were taken every hour (0.14 g/mL Ga and 0.020 g/mL AgF as precursors in DMF solution). The experiments were repeated twice.

FIG. 21 shows a proposed reaction mechanism of CO₂ reduction. a, Cyclic voltammetry curve of the Ga⁺—Ga cycle with Ga droplets and Ag_{0.72}Ga_{0.28} rods as the working electrode. Inset: Cyclic voltammetry curve with only Ga droplets as the working electrode. b, EPR spectra of the carbon dioxide radical (CO₂^{⋅-}) addition to DMPO. (\textcircled{1} Spectrum of DMPO added into the reaction solution for 30 min without bubbling CO₂. \textcircled{2} Spectrum of DMPO—CO₂^{⋅-} by ultraviolet photolysis of 100 mM NaHCO₂ and 100 μM H₂O₂ in the presence of 50 mM DMPO in Milli-Q water for 10 min, followed by the addition of photolytic 1.0 mL solution into 20 mL DMF for EPR analysis. \textcircled{3} Spectrum of DMPO—CO₂^{⋅-} with DMPO added into the reaction solution for 30 min when CO₂ reduction is proceeding). c, Proposed catalytic cycle for CO₂ reduction on the surface of Ga droplets with Ag_{0.72}Ga_{0.28} rods working as the functional material.

FIG. 22 shows cyclic voltammetry characterisation. Cyclic voltammetry curve when using Ga particles and Ag_{0.72}Ga_{0.28} (non-rod morphology—mix of AgI with Ga) as the working electrode.

FIG. 23 shows NMR results. a, NMR spectra of DMF before \textcircled{1} and after \textcircled{2} 5 hours of CO₂ reaction. b, NMR spectra of 90% DMF with 10% ETA as the reaction solution before \textcircled{1} and after \textcircled{2} CO₂ reduction for 5 hours, and the spectrum of spike experiment \textcircled{3} was acquired with the addition of 0.10 μL formic acid into \textcircled{2}.

FIG. 24 shows the CO₂ conversion results using overhead stirring as the mechanical energy input. a, Raman spectra of produced carbon on the surface of the catalysts using overhead stirring as the input energy at different rotation speed for 24 hours (utilizing a 50 mL reactor containing 0.14 g/mL Ga and 0.020 g/mL AgF in 90% DMF with 10% ETA solution). b, TGA results of the carbon produced at different rotation for 24 hours CO₂ conversion. The mass of the sample from 2.0 mL reaction solution was found to be 10.2 mg (300 rpm), 18.8 mg (400 rpm), 17.6 mg (500 rpm) and 15.75 mg (1000 rpm), respectively. c, The trend of produced carbonaceous materials (per hour in per millilitre reaction solution) as the rotation speed increases.

FIG. 25 shows a Raman spectroscopic measurement of carbon materials of an embodiment of a SnBi liquid metal nano alloy catalyst. Raman spectra peaks at 1350 and 1600 cm⁻¹ indicate strong concentration of carbonaceous materials.

FIG. 26 shows Scanning Electron Microscopy (SEM) micrograph image and Energy-dispersive X-ray spectroscopy (EDS) analysis of an embodiment of a SnBi liquid metal nano alloy catalyst reduction (a) before reaction; and (b) after reaction.

FIG. 27 shows Raman spectra peaks at 1350 and 1600 cm⁻¹ of an embodiment of a Ga/PtCl₄ liquid metal catalyst of the present invention correlating to carbonaceous materials from methane conversion.

FIG. 28 shows Scanning Electron Microscopy (SEM) micrograph image and elemental mapping of the carbon materials formed after methane conversion.

FIG. 29 shows a gas chromatography analysis of the output gas showing hydrogen gas production in an embodiment of the invention.

FIG. 30 shows Scanning Electron Microscopy (SEM) micrograph image and elemental mapping of the catalyst or catalytic system of an embodiment of the present invention.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise. Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a process or method does not preclude the presence of additional steps or intervening steps between those steps expressly identified. Steps of a process or method may be performed in a different order than those described herein without departing from the scope of the disclosure. Similarly, it is also to be understood that the mention of one or more components in a process or system does not preclude the presence of additional components or intervening components between those components expressly identified.

### DETAILED DESCRIPTION

The skilled addressee will understand that the invention comprises the embodiments and features disclosed herein as well as all combinations and/or permutations of the disclosed embodiments and features.

According to the present invention, there is provided a catalyst or catalytic system comprising liquid metal droplets dispersed in a solvent.

### Catalyst or Catalytic System

The catalysts or catalytic system described herein may be for catalysing any suitable reaction. In particular, the catalysts or catalytic systems described herein may be suitable for reactions catalysed by elemental metals. The present invention contemplates that a variety of different catalytic metals may be incorporated into the liquid metal droplets in the solvents described herein and is thereby not intended to be limited to the performance of any one single reaction. In one embodiment, however, the catalyst or catalytic system described herein is suitable for the reduction of CO₂ to yield solid carbon and oxygen gas. In another embodiment, the catalyst or catalytic system described herein is suitable for reduction of methane to yield solid carbon and hydrogen gas.

In preferred embodiments, the catalyst or catalytic system herein is not immobilised or adsorbed onto a solid support, but is used in the form of dispersed liquid metal droplets in a solvent (suspension). In some embodiments, the catalyst or catalytic system of the present invention can capture and/or dissolve the reactants (for example when introduced in the form of an input gas).

Aspects of the catalyst or catalytic system are detailed below.

### Liquid Metal

The catalysts or catalytic systems described herein comprise liquid metal droplets dispersed in a solvent. In some embodiments, the catalyst or catalytic system comprises liquid metal droplets and a co-contributor dispersed in a solvent. In some embodiments, the catalyst or catalytic system comprises liquid metal droplets and an intermetallic phase dispersed in a solvent. As will be understood by a person skilled in the art, intermetallic phase (also known as an intermetallic compound, intermetallic alloy, ordered intermetallic alloy, and a long-range-ordered alloy) is a type of metallic alloy that forms an ordered crystalline solid-state compound of two or more metals. The intermetallic phase can be composed of any one of the metals as described herein including the base and/or catalytic metals and salts thereof. The term “liquid metal” as used herein refers to a metal or alloy, for example, eutectic alloy, that exists in a liquid state under the conditions in which the catalyst or catalytic system is manufactured and/or used. The conditions in which the catalyst or catalytic system is manufactured and/or used are preferably between about −50° C. and 300° C. and between 0.5 and 3 atm, e.g., between about 0° C. and 100° C. and 0.9 and 1.5 atm. Accordingly, preferably the liquid metal is a metal or an alloy that is a liquid at room temperature and pressure. However, in other embodiments, the liquid metal is a metal or an alloy that is a liquid when heated, especially when heated up to temperatures not exceeding about 300° C.

For example, in certain embodiments, the liquid metal is a metal or alloy having a melting point (at atmospheric pressure) of less than about 350° C., e.g., less than about 300° C., less than 250° C., or less than 200° C., or less than 150° C., or less than 100° C., or less than 50° C., e.g., the liquid metal may be a metal or alloy having a melting point of between −50° C. and 350° C., −50° C. and 300° C., or of between 0° C. and 300° C., or of between 0° C. and 150° C., or between 50° C. and 250° C., or between 100° C. and 300° C., or between 50° C. and 250° C., or between 150° C. and 300° C., or between 200° C. and 300° C., or between 20° C. and 100° C., e.g., of −50° C., 0° C., 20° C., 30° C., 40° C., 50° C., 60° C., 100° C., 150° C., 200° C., 250° C., or 300° C. Preferably, the liquid metal has a melting point of less than 300° C., less than 200° C., less than 150° C., less than 100° C., and even more preferably, a melting point of below 60° C., e.g., between −30° C. and 100° C., or between −30° C. and 60° C. The advantage of using liquid metals having melting points below 300° C., less than 200° C., less than 150° C., and more preferably below 100° C., and more preferably below 60° C., is that a wider variety of solvents, including environmentally friendly solvents such as water, may be used under the milder conditions. Further, by using low melting point liquid metals, the present invention avoids the use of high temperatures required to produce traditional molten catalytic metals (particularly transition metals). Such high temperature molten metals are known and used in the prior art to perform catalysis via methods such as bubbling gas through the molten metals at temperatures of >600° C., and even >1000° C.

The liquid metal described herein will generally comprise a catalytic metal element or a catalytically active alloy in a ‘base’ metal or alloy. The catalytic metal element may be a transition metal, post-transition metal or may be an actinide metal, or may be a lanthanide metal. The catalysts or catalytic system described herein may therefore be suitable for any reaction capable of being catalysed by an elemental metal or by a catalytically active alloy, including nanoparticulate metals/alloys, as these may be incorporated into a ‘base’ and thereby (whether by formation of a eutectic mixture and/or by virtue of the base being a liquid metal itself) form a liquid metal. In one embodiment, the catalyst or catalytic system described herein is suitable for reduction of carbon dioxide to yield solid carbon and oxygen gas. In such embodiments, catalytic metals suitable for catalysing this reduction reaction, such as silver and gold, may be used in combination with a base metal or alloy such as liquid gallium or Galinstan or EGaln. In preferred embodiments, the catalytic metal is in the form of a salt, such as silver, platinum or nickel salts. The catalytic metal in the form of a salt can then be mixed with a base such as liquid gallium.

Whilst the present inventors consider that any liquid metal can be used in the invention described herein, exemplary liquid metals are described in further detail below.

In certain embodiments, the base metal is selected from post transition metals. In some embodiments, the base metal is selected from the group consisting of gallium, indium, lead, thallium, tin, bismuth, mercury and combinations thereof. In some embodiments, the base metal further comprises an alkali metal, alkaline earth metal, actinide metal, lanthanide metal, transition metal and combinations thereof. In some embodiments, the catalytic metal element further comprises nanoparticles. In preferred embodiments, the base metal has a melting point less than 350° C., preferably less than 330° C. In preferred embodiments, base metal is miscible with the further additives such that when the base liquid metal is agitated to form and disperse droplets (such as sonication), the catalytically active alloy is homogeneous.

In some embodiments, the liquid metal comprises gallium. Pure gallium has a melting point of about 30° C., and alloys of gallium with other metals may have melting points close to or at room temperature also. In one embodiment, the liquid metal comprises gallium and one or more transition metals. For example, the liquid metal may comprise gallium in alloy with one or more of copper, nickel, cobalt, iron, manganese, chromium, vanadium, palladium, platinum, gold, silver, ruthenium, rhodium, and iridium. In another embodiment, liquid metal comprises gallium and one or more lanthanide metals. For example, the liquid metal may comprise gallium in alloy with cerium. In a further embodiment, the liquid metal comprises gallium and one or more actinide metals. In one embodiment, the catalysts or catalytic systems described herein comprise a liquid metal comprising gallium in alloy with a metal selected from the group consisting of silver, nickel, palladium, platinum, gold, silver, ruthenium, rhodium, iridium and cerium. In another embodiment, the catalysts or catalytic systems described herein comprise a liquid metal comprising gallium in alloy with a metal selected from the group consisting of silver, gold, and iridium.

In some embodiments, the liquid metal is a post-transition metal. In certain embodiments, the post-transition metal is selected from the group consisting of gallium, indium, lead, thallium, tin, bismuth, mercury and combinations thereof. In some embodiments, the post-transition metal can comprise in alloy an alkali metal, alkaline earth metal, actinide metal, lanthanide metal, transition metal and combinations thereof. In certain embodiments, the alkali metal is selected from the group consisting of lithium, sodium, potassium, rubidium, caesium, francium and combinations thereof. In certain embodiments, the alkaline earth metal is selected from the group consisting of beryllium, magnesium, calcium, strontium, barium, radium and combinations thereof. In certain embodiments, the actinide metal is selected from the group consisting of neptunium, plutonium, americium, curium, berkelium, californium, einsteinium, fermium, mendelevium, nobelium, lawrencium and combinations thereof. In certain embodiments, the lanthanide metal is selected from the group consisting of lanthanum, cerium, praseodymium, neodymium, promethium, samarium, europium, gadolinium, terbium, dysprosium, holmium, erbium, thulium, ytterbium, lutetium and combinations thereof. In certain embodiments, the transition metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold, mercury, actinium, rutherfordium, dubnium, seaborgium, bohrium, hassium, meitnerium, darmstadtium, roentgenium, copernicium and combinations thereof.

It is also anticipated that analogous to the foregoing description of alloys of gallium, the liquid metal used herein may be an amalgam of mercury. Unless indicated otherwise, the percentages are by weight.

In one embodiment, the liquid metal comprises up to 99.9% post-transition metal by weight. In other embodiments, the liquid metal comprises between 50% and 99.9% post-transition metal and between 50% and 0.1% of an alkali metal, alkaline earth metal, actinide metal, lanthanide metal, transition metal or a combination thereof, the liquid metal comprises between 60% and 99.9% post-transition metal and between 40% and 0.1% of an alkali metal, alkaline earth metal, actinide metal, lanthanide metal, transition metal or a combination thereof, between 70% and 99.9% post-transition metal and between 30% and 0.1% of an alkali metal, alkaline earth metal, actinide metal, lanthanide metal, transition metal or a combination thereof, between 80% and 99.9% post-transition metal and between 20% and 0.1% of an alkali metal, alkaline earth metal, actinide metal, lanthanide metal, transition metal or a combination thereof, between 90% and 99.9% post-transition metal and between 10% and 0.1% of an alkali metal, alkaline earth metal, actinide metal, lanthanide metal, transition metal or a combination thereof, between 95% and 99.9% post-transition metal and between 5% and 0.1% of an alkali metal, alkaline earth metal, actinide metal, lanthanide metal, transition metal or a combination thereof, between 97% and 99.5% post-transition metal and between 3% and 0.5% of an alkali metal, alkaline earth metal, actinide metal, lanthanide metal, transition metal or a combination thereof. In some embodiments, the liquid metal comprises 97% post-transition metal and 3% of an alkali metal, alkaline earth metal, actinide metal, lanthanide metal, transition metal or a combination thereof, 98% post-transition metal and 2% of an alkali metal, alkaline earth metal, actinide metal, lanthanide metal, transition metal or a combination thereof, 99% post-transition metal and 1% of an alkali metal, alkaline earth metal, actinide metal, lanthanide metal, transition metal or a combination thereof, 99.5% post-transition metal and 0.5% of an alkali metal, alkaline earth metal, actinide metal, lanthanide metal, transition metal or a combination thereof.

For liquid metals comprising gallium in alloy with another metal, e.g., a transition metal, a lanthanide or an actinide, the gallium may be present in the alloy in any suitable proportion by weight. For example, the liquid metal may be an alloy comprising up to 99.9% gallium and at least 0.1% of the other (transition, lanthanide or actinide) metal by weight, e.g., may be an alloy comprising between 90 and 99.9% gallium and between 10 and 0.1% of the other (transition, lanthanide or actinide) metal, or may be an alloy comprising between 95 and 99.9% gallium and between 5 and 0.1% of the other (transition, lanthanide or actinide) metal, or may be an alloy comprising between 97 and 99.5% gallium and between 3 and 0.5% of the other (transition, lanthanide or actinide) metal, e.g., may be an alloy comprising 97% gallium and 3% of the other (transition, lanthanide or actinide) metal, or may be an alloy comprising 98% gallium and 2% of the other (transition, lanthanide or actinide) metal, or may be an alloy comprising 99% gallium and 1% of the other (transition, lanthanide or actinide) metal, or may be an alloy comprising 99.5% gallium and 0.5% of the other (transition, lanthanide or actinide) metal. Similar proportions may be used if the liquid metal is an amalgam of mercury.

For example, the liquid metal may be an alloy comprising between 70 and 99.9% gallium and between 30 and 0.1% silver, e.g., between 70 and 75% gallium and between 30 and 25% silver, between 80 and 85% gallium and between 20 and 15% silver, between 85 and 95% gallium and between 15 and 5% silver, between 90 and 99% gallium and between 10 and 1% silver, between 95 and 99.9% gallium and between 5 and 0.1% silver, or between 97 and 99.5% gallium and between 3 and 0.5% silver, e.g., 80% gallium and 20% silver, 85% gallium and 15% silver, 90% gallium and 10% silver, 95% gallium and 5% silver, 97% gallium and 3% silver, or 98% gallium and 2% silver, or 99% gallium and 1% silver, or 99.5% gallium and 0.5% silver.

In some embodiments, the catalyst or catalytic system may be an alloy formed using a mixture of base metal or alloy such as gallium and a catalytic metal salt. In some embodiments, the catalytic metal salt is selected from the group consisting of a catalytic metal chloride, catalytic metal fluoride, catalytic metal bromide, catalytic metal iodide, catalytic metal nitrate, catalytic metal triflate and combinations thereof. In preferred embodiments, the catalytic metal salt is a silver salt. In preferred embodiments, the catalytic metal salt is selected from the group consisting of a silver chloride, silver fluoride, silver bromide, silver iodide, silver triflate and combinations thereof. In more preferred embodiments, the catalytic metal salt is a silver fluoride.

In some embodiments, the catalyst or catalytic system is an alloy formed using a mixture of gallium and a catalytic metal salt in weight ratio of between about 1:1 to about 60:1, between about 2:1 to about 50:1, between about 20:1 to about 50:1, between about 2:1 to about 20:1, between about 5:1 to about 10:1, between about 2:1 to about 20:1, between about 2:1 to about 10:1 and more preferably about 7:1. In some embodiments, the catalyst or catalytic system is an alloy formed using a mixture of gallium and a catalytic metal salt in weight ratio of between about 60:1 to about 1:60, between about 50:1 to about 1:50, between about 30:1 to about 1:30, between about 20:1 to about 1:20, between about 5:1 to about 10:1, between about 2:1 to about 20:1, between about 2:1 to about 10:1 and more preferably about 5:1. In some embodiments, the catalytic metal salt is one or more of a copper, nickel, cobalt, iron, manganese, chromium, vanadium, palladium, platinum, gold, silver, ruthenium, rhodium, and iridium salt. In preferred embodiments, the catalytic metal salt is a silver salt.

In some embodiments, the catalyst or catalytic system is an alloy formed using a mixture of tin and bismuth and salts thereof in a weight ratio of between about 1:60 to about 60:1, between about 1:50 to about 50:1, between about 1:30 to about 30:1, between about 1:20 to about 20:1, between about 1:10 to about 10:1, between about 1:5 to about 5:1, between about 1:4 to about 4:1, between about 1:3 to about 3:1, and about 0.5:0.7.

In some embodiments, the catalyst or catalytic system is an alloy formed using a mixture of gallium and a catalytic metal in weight ratio of between about 1:1 to about 60:1, between about 2:1 to about 50:1, between about 20:1 to about 50:1, between about 2:1 to about 20:1, between about 5:1 to about 10:1, between about 2:1 to about 20:1, between about 2:1 to about 10:1 and more preferably about 7:1. In some embodiments, the catalytic metal is one or more of copper, nickel, cobalt, iron, manganese, chromium, vanadium, palladium, platinum, gold, silver, ruthenium, rhodium, and iridium. In preferred embodiments, the catalytic metal is silver.

In some embodiments, the catalyst or catalytic system comprises gallium liquid metal droplets and Ag_{0.72}Ga_{0.28} dispersed in a solvent. The Ag_{0.72}Ga_{0.28}, an intermetallic phase, is formed when energy is applied (such as sonication or agitation) to a gallium liquid metal and a silver salt. In some embodiments, the intermetallic phase of Ag_{0.72}Ga_{0.28} is in the shape of a rod, sphere and combinations thereof. In preferred embodiments, the intermetallic phase of Ag_{0.72}Ga_{0.28} is in the shape of a rod.

Alternatively, the liquid metal may be an alloy comprising between 80 and 99.9% gallium and between 20 and 0.1% gold, e.g., between 85 and 95% gallium and between 15 and 5% gold, between 90 and 99% gallium and between 10 and 1% gold, between 95 and 99.9% gallium and between 5 and 0.1% gold, or between 97 and 99.5% gallium and between 3 and 0.5% gold, e.g., 80% gallium and 20% gold, 85% gallium and 15% gold, 90% gallium and 10% gold, 95% gallium and 5% gold, 97% gallium and 3% gold, or 98% gallium and 2% gold, or 99% gallium and 1% gold, or 99.5% gallium and 0.5% gold. Alternatively, the liquid metal may be an alloy comprising between 80 and 99.9% gallium and between 20 and 0.1% cerium, e.g., between 85 and 95% gallium and between 15 and 5% cerium, between 90 and 99% gallium and between 10 and 1% cerium, between 95 and 99.9% gallium and between 5 and 0.1% cerium, or between 97 and 99.5% gallium and between 3 and 0.5% cerium, e.g., 80% gallium and 20% cerium, 85% gallium and 15% cerium, 90% gallium and 10% cerium, 95% gallium and 5% cerium, 97% gallium and 3% cerium, or 98% gallium and 2% cerium, or 99% gallium and 1% cerium, or 99.5% gallium and 0.5% cerium.

In other embodiments, the liquid metal comprises a ‘base’ alloy of gallium, indium and tin, referred to herein as “galinstan”, further in combination with, e.g., one or more transition metals. In such embodiments, the galinstan will generally comprise between 60% and 95% gallium, 5% and 25% indium and 0.01% and 16% tin by weight, e.g., comprise between 60% and 75% gallium, 15% and 25% indium and 5% and 15% tin by weight, e.g., comprise 68.5% gallium, 21.5% indium and 10% tin by weight. In some embodiments, the galinstan may further comprise bismuth and/or antimony in an amount of <1.5% by weight. For example, the liquid metal may comprise galinstan in alloy with one or more of copper, nickel, cobalt, iron, manganese, chromium, vanadium, palladium, platinum, gold, silver, ruthenium, rhodium, and iridium. In another embodiment, liquid metal comprises galinstan and one or more lanthanide metals. For example, the liquid metal may comprise galinstan in alloy with cerium. In a further embodiment, the liquid metal comprises galinstan and one or more actinide metals.

For liquid metals comprising galinstan in alloy with another metal, e.g., a transition metal, a lanthanide or an actinide, the galinstan may be present in the alloy in any suitable proportion by weight. For example, the liquid metal may be an alloy comprising up to 99.9% galinstan and 0.1% of the other (transition, lanthanide or actinide) metal, e.g., may be an alloy comprising between 80 and 99.9% galinstan and between 20 and 0.1% of the other (transition, lanthanide or actinide) metal, or may be an alloy comprising between 85 and 99% galinstan and between 15 and 1% of the other (transition, lanthanide or actinide) metal, or may be an alloy comprising between 90 and 99.9% galinstan and between 10 and 0.1% of the other (transition, lanthanide or actinide) metal, or may be an alloy comprising between 95 and 99.9% galinstan and between 5 and 0.1% of the other (transition, lanthanide or actinide) metal, or may be an alloy comprising between 97 and 99.5% galinstan and between 3 and 0.5% of the other (transition, lanthanide or actinide) metal, e.g., may be an alloy comprising 80% galinstan and 20% of the other (transition, lanthanide or actinide) metal, may be an alloy comprising 85% galinstan and 15% of the other (transition, lanthanide or actinide) metal, may be an alloy comprising 90% galinstan and 10% of the other (transition, lanthanide or actinide) metal, may be an alloy comprising 95% galinstan and 5% of the other (transition, lanthanide or actinide) metal, may be an alloy comprising 97% galinstan and 3% of the other (transition, lanthanide or actinide) metal, or may be an alloy comprising 98% galinstan and 2% of the other (transition, lanthanide or actinide) metal, or may be an alloy comprising 99% galinstan and 1% of the other (transition, lanthanide or actinide) metal, or may be an alloy comprising 99.5% galinstan and 0.5% of the other (transition, lanthanide or actinide) metal.

For example, the liquid metal may be an alloy comprising between 80 and 99.9% galinstan and between 20 and 0.1% silver, e.g., between 85 and 99.9% galinstan and between 15 and 0.1% silver, between 90 and 99.9% galinstan and between 10 and 0.1% silver, between 95 and 99.9% galinstan and between 5 and 0.1% silver, or between 97 and 99.5% galinstan and between 3 and 0.5% silver, e.g., 97% galinstan and 3% silver, or 98% galinstan and 2% silver, or 99% galinstan and 1% silver, or 99.5% galinstan and 0.5% silver. Alternatively, the liquid metal may be an alloy comprising between 80 and 99.9% galinstan and between 20 and 0.1% gold, e.g., between 95 and 99.9% galinstan and between 5 and 0.1% gold, or between 97 and 99.5% galinstan and between 3 and 0.5% gold, e.g., 97% galinstan and 3% gold, or 98% galinstan and 2% gold, or 99% galinstan and 1% gold, or 99.5% galinstan and 0.5% gold. Alternatively, the liquid metal may be an alloy comprising between 80 and 99.9% galinstan and between 20 and 0.1% cerium, e.g., between 95 and 99.9% galinstan and between 5 and 0.1% cerium, or between 97 and 99.5% galinstan and between 3 and 0.5% cerium, e.g., 97% galinstan and 3% cerium, or 98% galinstan and 2% cerium, or 99% galinstan and 1% cerium, or 99.5% galinstan and 0.5% cerium.

In other embodiments, the liquid metal comprises a ‘base’ alloy of bismuth, indium and tin, referred to herein as “Field's metal”, further in combination with, e.g., one or more transition metals or lanthanides. In such embodiments, the Field's metal will generally comprise between 30% and 35% bismuth, 15% and 18% tin, and 48% and 53% indium by weight, e.g., comprise 32.5% gallium, 16.5% tin and 51% indium by weight. In yet other embodiments, the liquid metal comprises a ‘base’ alloy of bismuth, lead and tin, referred to herein as “Rose's metal”, further in combination with, e.g., one or more transition metals or lanthanides. In such embodiments, the Rose's metal will generally comprise between 45% and 55% bismuth, 20% and 30% lead, and 20% and 30% tin by weight, e.g., comprise 50% bismuth, 25% lead and 25% tin by weight. In yet further embodiments, the liquid metal comprises a ‘base’ alloy of bismuth, lead, cadmium and tin, referred to herein as “Wood's metal”, further in combination with, e.g., one or more transition metals or lanthanides. In such embodiments, the Wood's metal will generally comprise between 45% and 55% bismuth, 20% and 30% lead, 5 to 15% cadmium and 10% and 20% tin by weight, e.g., comprise 50% bismuth, 26.7% lead, 13.3% tin, and 10% cadmium by weight. Other suitable liquid metal ‘base’ alloys such as cerrosafe or cerrolow may also be used, with other variations of the liquid metal ‘base’ alloy having melting points especially of below 100° C. are expected to be useful in the present invention.

In some embodiments, the liquid metal comprises Field's metal, Rose's metal, Wood's metal or other ‘base’ alloy is further in alloy with one or more of copper, nickel, cobalt, iron, manganese, chromium, vanadium, palladium, platinum, gold, silver, ruthenium, rhodium, and iridium. In another embodiment, the liquid metal comprises Field's metal, Rose's metal or Wood's metal and one or more lanthanide metals. For example, the liquid metal may comprise Field's metal, Rose's metal or Wood's metal in alloy with cerium. In a further embodiment, the liquid metal comprises Field's metal, Rose's metal or Wood's metal and one or more actinide metals.

For liquid metals comprising Field's metal, Rose's metal, Wood's metal or other ‘base’ alloy in alloy with another metal, e.g., a transition metal, a lanthanide or an actinide, the Field's metal, Rose's metal or Wood's metal may be present in the alloy in any suitable proportion by weight. For example, the liquid metal may be an alloy comprising between 80 and 99.9% Field's metal, Rose's metal or Wood's metal and between 20 and 0.1% of the other (transition, lanthanide or actinide) metal.

Accordingly, the liquid metal herein may comprise a metal or ‘base’ alloy comprising one or more metals selected from the group consisting of: mercury, bismuth, lead, tin, indium, gallium, cadmium and antimony, in further alloy with one or more metals selected from the group consisting of: silver, nickel, palladium, platinum, gold, silver, ruthenium, rhodium, iridium and cerium.

The liquid metal droplets in the solvents described herein may have any suitable average diameter. In some embodiments, the liquid metal droplets will have an average diameter of less than about 100 μm, e.g., less than 90 μm, less than 80 μm, less than 70 μm, less than 60 μm, less than 50 μm, less than 40 μm, less than 30 μm, less than 20 μm, less than 10 μm, less than 5 μm, or less than 1 μm, e.g., an average diameter of between 0.1 and 100 μm, e.g., between 0.1 and 10 μm, between 1 and 10 μm, or between 0.5 and 20 μm, or between 10 and 50 μm, or between 1 and 50 μm, or between 25 and 75 μm, or between 50 and 100 μm. For example, the liquid metal droplets may have an average diameter of 100 μm, 90 μm, 80 μm, 70 μm, 60 μm, 50 μm, 40 μm, 30 μm, 20 μm, 10 μm, 5 μm, 1 μm, 0.5 μm, or 0.1 μm. In some embodiments, the liquid metal droplets will have a median diameter of between 50 nm and 1000 nm, between 50 nm and 800 nm, between 50 nm and 500 nm, between 50 nm and 300 nm, preferably between 100 nm and 300 nm and more preferably between 200 nm and 300 nm. It will be appreciated that smaller average diameters of, e.g., between 0.1 and 10 μm are particularly advantageous as smaller droplets will necessarily have a higher surface area to volume ratio than larger droplets, e.g., of >100 μm. Higher surface area to volume ratios in turn may allow more catalytic active sites to be available to reactants and for the reaction to proceed at higher catalytic activities. However, the inventors predict that catalysis of different reactions will proceed with different catalytic activities depending on the chemical nature of the liquid metal as well as the particular chemical reaction being catalysed, and therefore a suitable average droplet diameter may be selected based on the liquid metal and reaction conditions.

The particles of co-contributor or intermetallic phase dispersed in the solvents described herein may have any suitable median diameter. In some embodiments, the particles of intermetallic phase will have a median diameter of between 50 nm and 1000 nm, between 50 nm and 800 nm, between 50 nm and 500 nm, between 50 nm and 300 nm, preferably between 50 nm and 200 nm and more preferably between 100 nm and 200 nm.

Methods of producing liquid metal alloys as described above will be known to those in the art. However, by way of illustrative example, pure metal powder(s) may be ground into a liquid metal or alloy base using mixing means such as a mortar and pestle or mill until the metal powder(s) are adequately dispersed in the metal/alloy base, e.g., in some embodiments until they are completely homogeneously dispersed in the metal/alloy base. Dispersion of the metal powder(s) may be assessed by, e.g., visual inspection, where a smooth appearance indicates complete dissolution of the metal powder, or by microscopy and/or spectroscopic means. Liquid metal alloys can also be produced by melting, for example, by melting a metal with a liquid metal or alloy base. Melting can be performed in some embodiments by using a furnace, crucible, electromagnetic heating or oven for example.

### Solvent

The catalysts or catalytic systems described herein comprise liquid metal droplets dispersed in a solvent. The solvent is typically one in which the solubility of the liquid metal is zero or negligible. Preferred solvents are those that are chemically and thermally stable. The selection of solvent can also depend on environmental considerations and configuration of the reactor. In preferred embodiments, the solvent used herein is not consumed by the reaction catalysed by the liquid metal. In other preferred embodiments, the solvent used herein does not take part in, or is inert in, the reaction catalysed by the liquid metal.

Although any suitable solvent may be selected, the solvents used in the catalysts or catalytic systems of the invention herein preferably have a boiling point (at atmospheric pressure) of greater than 25° C. and less than about 300° C., e.g., of greater than 25° C. and less than 250° C., or less than 200° C., or less than 150° C., or less than 100° C., e.g., the solvent has a boiling point of between 25° C. and 300° C., or of between 50° C. and 200° C., or of between 75° C. and 150° C., or of between 100° C. and 200° C., or of between 150° C. and 300° C., e.g., of 30° C., 40° C., 50° C., 60° C., 100° C., 150° C., 200° C., 250° C., or 300° C. Preferably, the solvent has a boiling point of between 80 and 180° C.

It is also envisaged herein that ionic liquids (i.e., salts having melting points of less than about 100° C.) may be used as solvents. In some embodiments, the ionic liquid is a salt of 1-alkyl-3-methylimidazolium, 1-alkyl-1-pyrrolidinium, 1-alkylpyridinium, trialkylsulfonium, n-alkylphosphonium, tetraalkylammonium, tetraalkylphosphonium, dicyanamide, acetate, halogen, trifluoroacetate, hexafluorophosphate, tetrafluoroborate, alkyl sulfonate, alkyl sulfate, alkyl phosphate, bis(trifluoromethylsulfonyl)imide. In preferred embodiments, the ionic liquid is selected from the group consisting of 1-butylpyridinium tetrafluoroborate, trihexyl(tetradecyl)-phosphonium imidazole, 1-butyl-3-methyl-imidazolium hexafluorophosphate, (trifluoromethyl sulfonyl)imide-based ionic liquid, 1-butyl-3-methyl-imidazolium acetate, allyl-pyridinium bis(trifluoromethylsulfonyl)imide and combinations thereof.

The solvent used herein may be, for example, an organic solvent such as alkanolamines, dimethylformamide, acetonitrile, cyclohexane, diethylene glycol dimethyl ether, ethylene glycol, glycerol, 2-amino-2-methyl-1-propanol, benzylamine, piperazine, 1,2-ethanediamine, 3-methylamine propylamine, pyridine, triethylamine, xylene, propanol, butanol, ethanol, methanol, acetone, methyl acetate, acetylacetone, 1,4-dioxane, 2-methoxyethyl acetate, N,N-dimethylacetamide, 2-butoxyethyl acetate, N-tert-butylformamide, 2-(2-butoxyethoxy)ethyl acetate, formamide, poly(ethylene glycol), carbonate (such as sodium, potassium or calcium carbonate), bicarbonate (such as sodium or potassium bicarbonate), etc., or it may be water, or it may be a mixture of any two or more of these solvents. In preferred embodiments, the solvent can dissolve the reagent such as CO₂ at high concentrations. In some embodiments, the alkanolamine is selected from the group consisting of monoethanolamine, diglycolamine, diethanolamine, diisopropanolamine, dimethyl monoethanolamine, methyldiethanolamine, triethanolamine and combinations thereof. In some embodiments, the solvent is an alkanolamine such as ethanolamine. In some embodiments, the solvent is dimethylformamide. In some embodiments, the solvent is selected from the group consisting of an alkanolamine such as ethanolamine, dimethylformamide and combinations thereof.

In one embodiment, the solvent is selected from the group consisting of: dimethylformamide, ethanolamine, glycerol, acetonitrile and water, or a combination of two or more of these.

In some embodiments, the solvent is selected such that it has a reactant solubility of between 20 mg/L and 5 g/L at 25° C., between 20 mg/L and 1 g/L at 25° C., between 20 mg/L and 0.5 g/L at 25° C., between 20 mg/L and 50 mg/L at 25° C., between 0.3 g/L and 0.5 g/L at 25° C., between 1 and 5 g/L at 25° C., between 1 and 300 g/L at 25° C., between 1 and 250 g/L at 25° C., between 1 and 200 g/L at 25° C., between 1 and 100 g/L at 25° C., between 1 and 50 g/L at 25° C., between 1 and 30 g/L at 25° C., between 1 and 10 g/L at 25° C., between 1 and 4 g/L at 25° C. or between 2 and 5 g/L at 25° C.

In some embodiments, the solvent is selected such that it has a carbon dioxide solubility of between 20 mg/L and 250 g/L at 25° C., 20 mg/L and 5 g/L at 25° C., between 20 mg/L and 1 g/L at 25° C., between 20 mg/L and 0.5 g/L at 25° C., between 20 mg/L and 50 mg/L at 25° C., between 0.3 g/L and 0.5 g/L at 25° C., between 1 and 5 g/L at 25° C., between 1 and 300 g/L at 25° C., between 1 and 250 g/L at 25° C., between 1 and 200 g/L at 25° C., between 1 and 100 g/L at 25° C., between 1 and 50 g/L at 25° C., between 1 and 30 g/L at 25° C., between 1 and 10 g/L at 25° C., between 1 and 4 g/L at 25° C. or between 2 and 5 g/L at 25° C.

In some embodiments, the solvent is selected such that it has a methane solubility of between 20 mg/L and 5 g/L at 25° C., between 20 mg/L and 1 g/L at 25° C., between 20 mg/L and 0.5 g/L at 25° C., between 20 mg/L and 50 mg/L at 25° C., between 0.3 g/L and 0.5 g/L at 25° C., between 1 and 5 g/L at 25° C., between 1 and 300 g/L at 25° C., between 1 and 250 g/L at 25° C., between 1 and 200 g/L at 25° C., between 1 and 100 g/L at 25° C., between 1 and 50 g/L at 25° C., between 1 and 30 g/L at 25° C., between 1 and 10 g/L at 25° C., between 1 and 4 g/L at 25° C. or between 2 and 5 g/L at 25° C.

In some embodiments, the catalyst or catalytic system further comprises an acidifying agent added to the liquid metal and solvent. Acidifying the solvent may advantageously reduce any oxidation of the liquid metal surface by dissolving any metal oxides that may form on the liquid metal droplets before or during catalysis. Addition of one or more acidifying agents may be of particular relevance for reactions that form oxidisers such as the molecular oxygen produced by the reduction of carbon dioxide. Addition of one or more acidifying agents may also be of particular relevance where one or more reactants, or the solvent itself, is likely to comprise dissolved oxygen or another known oxidiser.

Any suitable acidifying agent may be used. Suitably, the acidifying agent is an inorganic acid such as phosphoric acid, sulfuric acid, nitric acid, hydrochloric acid, boric acid, or bromic acid. Other acids, such as organic acids like acetic acid, formic acid, citric acid, oxalic acid, or a sulfonic acid may alternatively be used. The acidifying agent may be included in the catalyst or catalytic system in any suitable concentration. For example, concentrations of between about 0.01 M and 10 M of the acid may be used. In some embodiments, the concentration of acid is between 0.01 M and 5 M, between 0.01 M and 3 M, between 0.01 M and 1 M, between 0.05 M and 0.5 M and preferably 0.1 M. In other embodiments, the catalyst or catalytic system comprises any suitable basifying agent which can be added to the liquid metal and solvent. In some embodiments, the base is selected from the group consisting of lithium hydroxide, sodium hydroxide, potassium hydroxide, calcium hydroxide, magnesium hydroxide, sodium carbonate, sodium bicarbonate, ammonium hydroxide, rubidium hydroxide, cesium hydroxide, calcium hydroxide, strontium hydroxide, barium hydroxide, tetramethylammonium hydroxide, guanidine, lithium diisopropylamide, lithium diethylamide, sodium amide, sodium hydride, lithium bis(trimethylsilyl)amide and combinations thereof.

The basifying agent may be included in the catalyst or catalytic system in any suitable concentration. For example, concentrations of between about 0.01 M and 10 M of the base may be used. In some embodiments, the concentration of base is between 0.01 M and 5 M, between 0.01 M and 3 M, between 0.01 M and 1 M, between 0.05 M and 0.5 M and preferably 0.1 M.

In other embodiments, the solvent may be a reactive solvent and be consumed in the reaction catalysed by the liquid metal (either directly or indirectly). In a further embodiment, the solvent herein may comprise a reactive solvent, e.g., may comprise up to 100% (v/v) reactive solvent, or up to 90% (v/v), or up to 70% (v/v), or up to 60% (v/v), or up to 50% (v/v), or up to 40% (v/v), or up to 30% (v/v), or up to 20% (v/v), or up to 10% (v/v), or up to 5% (v/v), e.g., may comprise between 50 and 75% (v/v) reactive solvent, or may comprise between 5 and 25% (v/v) reactive solvent, or may comprise between 20 and 75% (v/v) reactive solvent, or may comprise between 80 and 100% (v/v) reactive solvent, e.g., may comprise 5, 10, 20, 30, 40, 50, 60, 70, 80, 90 or 100% (v/v) reactive solvent. In certain embodiments, the reactive solvent is selected from the group consisting of methanol, ethanol, propanol, butanol and combinations thereof.

### Dispersion

The catalyst or catalytic system herein is described as comprising liquid metal droplets dispersed in a solvent. In some embodiments, the catalyst or catalytic system comprises liquid metal droplets and a co-contributor dispersed in a solvent. In some embodiments, the catalyst or catalytic system comprises liquid metal droplets and an intermetallic phase dispersed in a solvent. The dispersion need not be homogeneous, and the liquid metal droplets need not be uniform in size. However, in some embodiments, the catalyst or catalytic system herein may be an emulsion of liquid metal droplets dispersed in a solvent, meaning that the catalyst or catalytic system comprises a plurality of finely and substantially homogeneously dispersed liquid metal droplets in a liquid solvent, where the liquid metal droplets are highly or completely insoluble in the liquid solvent. In some embodiments, the liquid metal droplets have a narrow droplet size distribution.

The catalysts or catalytic systems herein are generally formed by applying energy to a combination of liquid metal in a solvent as further described below in the section entitled “Manufacture of the catalyst or catalytic system”. However, in brief, in one embodiment, the liquid metal and solvent are combined, and energy is applied to cause the liquid metal to form fine droplets in the solvent such that a dispersion is formed. Preferably, the energy is ultrasonic energy provided in the form of, e.g., an ultrasonic bath or probe. Accordingly, in one embodiment, the catalyst or catalytic system herein is formed by application of ultrasonic energy. Other embodiments may utilise mechanical force, e.g., rapid stirring or agitation.

Accordingly, in some embodiments, the catalyst or catalytic system herein may consist of liquid metal droplets dispersed in a solvent. In some embodiments, the catalyst or catalytic system herein may consist of liquid metal droplets and particles of a co-contributor dispersed in a solvent. In some embodiments, the catalyst or catalytic system herein may consist of liquid metal droplets and particles of an intermetallic phase dispersed in a solvent. Alternatively, the catalyst or catalytic system herein may comprise an acidifying agent in addition to the liquid metal droplets dispersed in a solvent. In such embodiments, the catalyst or catalytic system may be formed by application of energy, such as ultrasonic energy, and the dispersion of liquid metal droplets in the solvent may be maintained by continued application of that energy. In such embodiments, removal of the energy source may cause the dispersed liquid metal droplets to separate out of the solvent over time. In such embodiments, application of energy to the catalyst or catalytic system may be required for the duration of its use.

However, in other embodiments, the catalyst or catalytic system herein may comprise an emulsifying agent such as a surfactant in addition to the liquid metal droplets dispersed in a solvent. In such embodiments, the catalyst or catalytic system herein may further comprise an acidifying agent in addition to the emulsifier and liquid metal droplets dispersed in a solvent. In embodiments where the catalyst or catalytic system further comprises a surfactant, any suitable surfactant may be used. For example, the surfactant may be an anionic surfactant, a cationic surfactant or a non-ionic surfactant. Suitable anionic surfactants may include water-soluble salts of alkylbenzene sulfonates, alkyl sulfates, alkyl polyethoxy ether sulfates, paraffin sulfonates, alpha-olefin sulfonates, alpha-sulfocarboxylates and their esters, alkyl glyceryl ether sulfonates, fatty acid monoglyceride sulfates and sulfonates, alkyl phenol polyethoxy ether sulfates, 2-acryloxy-alkane-1-sulfonates, and beta-alkyloxy alkane sulfonates. Suitable non-ionic surfactants may include alkoxylated compounds produced by the condensation of alkylene oxide groups with an organic hydrophobic compound (aliphatic, aromatic or arylaliphatic). Suitable cationic surfactants may include tertiary and quaternary water-soluble amines, stearyl dimethyl benzyl ammonium chloride, a trialkyl tin complex having a high weight ratio of tertiary amine groups, benzalkonium chloride, amido alkyl amine oxides, and alkyl dimethylamine oxides. Suitable ampholytic surfactants may include water-soluble derivatives of aliphatic secondary and tertiary amines in which the aliphatic moiety can be straight chain or branched and wherein one of the aliphatic substituents contains from about 8 to 18 carbon atoms and one contains an anionic water-solubilising group, e.g. carboxy, sulfonate, sulfate, phosphate, or phosphonate. Suitable zwitterionic surfactants may include water soluble derivatives of aliphatic quaternary ammonium phosphonium and. sulfonium cationic compounds in which the aliphatic moieties can be straight chain or branched, and wherein one of the aliphatic substituents contains from about 8 to 18 carbon atoms and one contains an anionic water-solubilising group. Preferably, the surfactant comprises a semiconductor material.

The surfactant may be present in any suitable concentration, for example, at a concentration of up to about 10 wt % in the catalyst or catalytic system, or up to 9 wt %, 8 wt %, 7 wt %, 6 wt %, 5 wt %, 4 wt %, 3 wt %, 2 wt %, 1 wt %, 0.5 wt %, or 0.1 wt %. In embodiments where the catalyst or catalytic system further comprises a surfactant, the liquid metal may be dispersed as liquid metal droplets in the solvent by application of energy, such as ultrasonic energy, or some other source of energy, without the need for the dispersed liquid metal droplets to be maintained by continued application of that energy, or with a reduced need for the dispersed liquid metal droplets to be maintained by continued application of that energy. In such embodiments, the surfactant may be included in the catalyst or catalytic system in a sufficient concentration to prevent or substantially prevent the liquid metal droplets from separating from the solvent over time. In such embodiments, application of energy to the catalyst or catalytic system may be required to disperse the liquid metal, and may either no longer be required for the duration of use of the catalyst or catalytic system, or may only be required for part of the duration of use of the catalyst or catalytic system.

The proportion by volume of liquid metal in the catalyst or catalytic system may be any suitable proportion to effect catalysis, but by way of example may be up to 80% by volume (i.e., 80 mL liquid metal in 20 mL solvent), or up to 70%, up to 60%, up to 50%, up to 40%, up to 30%, up to 20%, or up to 10%, e.g., may be between 10% and 80%, or between 10% and 50%, or between 25% and 75%, or between 40% and 80%, or between 50% and 70%, e.g., may be 80%, 70%, 60%, 50%, 40%, 30%, 20%, or 10% by volume liquid metal.

### Manufacture of the Catalyst or Catalytic System

Described herein is process for producing a catalyst or catalytic system as described in the foregoing section entitled “Catalyst or catalytic system” comprising (a) combining a liquid metal with a solvent; and (b) applying energy to the combination of step (a) so as to disperse liquid metal droplets in the solvent, thereby forming the catalyst or catalytic system.

In the process for producing a catalyst or catalytic system as described herein, in step (a), a suitable volume of liquid metal (such as described in the section entitled “Dispersion” above) is added to a suitable volume of solvent, optionally with the addition of one or more other components such as an acidifying agent or surfactant.

In step (b), energy is applied to the combination of liquid metal and solvent of step (a) to disperse the liquid metal in the solvent in the form of liquid metal droplets. The energy may be any suitable energy. For example, the energy may be mechanical energy. One suitable example of suitable mechanical energy is vibrational or sound energy. The vibrational energy may be ultrasound energy applied through an ultrasound bath or wand. Accordingly, the vibrational energy preferably has a frequency in the ultrasound (also called ultrasonic) range. It will be appreciated that ultrasound energy is transmitted through the solvent through wave propagation which causes particle movements and pressure changes within the solvent, and the liquid metal, unable to withstand the pressure changes, is disrupted such that droplets form. The ultrasound energy may have any suitable frequency, but preferably has a frequency of between 20 kHz and 2 MHz. For example, the ultrasound energy preferably has a frequency of between 20 kHz and 100 kHz, or between 40 kHz and 60 kHz, or between 50 and 100 kHz, or between 100 and 200 kHz, or between 20 and 500 kHz, or between 100 and 750 kHz, or between 250 kHz and 1 MHz, or between 500 kHz and 1.5 MHz, or between 1 MHz and 2 MHz, e.g., a frequency of 20, 30, 40, 50, 60, 70, 80, 90, 100, 250, 500, 750, 1000, 1250, 1500 or 2000 kHz. The ultrasound energy may be delivered at any suitable power, but preferably the power of the ultrasound is between 2 W and 1 kW, between 2 W and 800 W, between 600 W to 1 kW, between 2 W and 600 W, between 2 W and 500 W, between 2 W and 200 W, between 2 W and 100 W, between 2 W and 50 W, between 300 W and 500 W, between 3500 W and 450 W, preferably 5 W or 410 W.

Alternatively, the energy may be mechanical energy provided in the form of rapid agitation in the form of stirring, whisking, beating or blending. Still further, the energy may comprise mechanical energy generated by the application of pressure, such as through use of a homogeniser, preferably a high-pressure homogeniser. Other methods of forming dispersions, emulsions and/or micro-emulsions will be known to those in the art and are envisaged to be suitable for use in the present invention.

The energy in step (b) may be applied for any suitable time to disperse the liquid metal in the solvent in the form of liquid metal droplets. The energy in step (b) may also be applied for any suitable time to disperse the liquid metal and a reactive metal salt in the solvent in the form of liquid metal droplets and particles of an intermetallic phase. The time required to disperse the liquid metal in the solvent is also likely to depend on the source of energy used. However, in some embodiments, energy is applied to the combination of liquid metal and solvent in step (b) for between 1 minute and 12 hours, e.g., between 1 minute and 6 hours, between 1 minute and 3 hours, between 1 and 60 minutes, between 10 and 60 minutes, for between 1 and 20 min, or between 5 and 30 min, or between 10 and 20 min, or between 5 and 15 min, or between 10 and 40 min, or between 25 and 50 min, or between 30 and 60 min, e.g., for 1, 2, 5, 10, 15, 20, 25, 30, 40, 50 or 60 min.

### Method for Catalysis

Also described herein is a method for catalysing a chemical reaction, the method comprising (i) providing a catalyst or catalytic system as described in the foregoing section entitled “Catalyst or catalytic system” comprising liquid metal droplets dispersed in a solvent; and (ii) contacting the catalyst or catalytic system with a reactant.

The methods described herein contemplate that there may be more than one reactant contacted with the catalyst or catalytic system, e.g., that there may be one, or there may be two, or there may even be three reactants in the chemical reaction.

In some embodiments, there is the proviso that the method for catalysing a chemical reaction described herein is devoid of applying an electrical current to the catalyst or catalytic system. However, in other embodiments, the method may further comprise step (ia) applying electrical current to the catalyst or catalytic system after step (i). In some embodiments, a voltage between 0.1 V to 2 V is applied to the catalyst or catalytic system, preferably between 0.2 V to 1.5 V, preferably between 0.3 V to 1.2 V, yet more preferably between 0.5 V to 1.2 V and most preferably between 1.0 V to 1.2 V.

In some embodiments, the catalyst or catalytic system provided in step (i) in the method for catalysing a chemical reaction described herein is produced by applying energy to the combination of liquid metal and solvent to disperse the liquid metal in the solvent. The energy is preferably vibrational energy in the form of ultrasound energy, e.g., applied through an ultrasound bath or wand. The ultrasound energy may have any suitable frequency and power as described in the foregoing section entitled “Manufacture of the catalyst or catalytic system”. In such cases, in some embodiments, the contacting of step (ii) may comprise contacting the catalyst or catalytic system with a reactant in the presence of ultrasound energy. The ultrasound energy may be continuous or may be intermittent (pulsed). In other embodiments, the contacting may be conducted without application of ultrasound energy.

Alternatively, the liquid metal may be dispersed in the solvent by applying mechanical force such as by rapid agitation in the form of stirring, whisking, beating or blending, or through the use of a high-pressure homogeniser. In such cases, the contacting of step (ii) may comprise contacting the catalyst or catalytic system with a reactant in the presence of mechanical force, e.g., in the presence of rapid agitation such as stirring, whisking, beating or blending. The rapid agitation may be continuous or intermittent (pulsed).

In preferred embodiments, the contacting in step (ii) is conducted at ambient and pressures of between about 95 and 105 kPa. However, in other embodiments, the contacting is conducted under higher pressures, such as at pressures of up to 5 atm, e.g., between 1.1 and 3 atm, or between 1.5 and 3.5 atm, or between 2 atm and 4 atm, or between 2.5 and 5 atm.

In preferred embodiments, the contacting in step (ii) is conducted at ambient temperatures of between about 15 and 30° C. However, in other embodiments, the contacting is conducted at temperatures of up to about 300° C., e.g., of up to 250° C., or up to 200° C., or up to 150° C., or up to 100° C., or up to 50° C., e.g., the contacting may be conducted at temperatures of between −50° C. and 300° C., or of between 0° C. and 300° C., or of between 0° C. and 150° C., or between 50° C. and 250° C., or between 100° C. and 300° C., or between 50° C. and 250° C., or between 150° C. and 300° C., or between 20° C. and 100° C., e.g., at a temperature of −50° C., 0° C., 20° C., 30° C., 40° C., 50° C., 60° C., 100° C., 150° C., 200° C., 250° C., or 300° C. Preferably, the contacting is conducted at temperatures of below 100° C., and more preferably below 60° C.

It is envisaged that the contacting may be conducted at any suitable combination of temperature and pressure as described above. For example, in preferred embodiments, the contacting is conducted at ambient temperature and pressure, e.g., between about 95 and 105 kPa and about 15 and 30° C.

The contacting may proceed for any suitable time to allow for conversion of the reactant(s) to product(s).

Reactant(s) may be supplied for contacting with the catalyst or catalytic system for any suitable period of time, e.g., for short term use, reactant may be supplied for contacting with the catalyst or catalytic system for a period of between 5 s and 2 h, or between 5 s and 60 s, or between 1 min and 10 min, or between 5 min and 30 min, or between 30 min and 1 hr, or between 1 hr and 2 hr, e.g., for 5 s, 30 s, 60 s, 2 min, 5 min, 10 min, 25 min, 40 min, 60 min, or 2 hr. Alternatively, longer term use of the catalyst or catalytic system may allow for reactant(s) to be continuously supplied to the catalyst or catalytic system for periods of 24 h or more, e.g., for several days.

The method for catalysing a chemical reaction described herein may further include the step of recovering one or more products of the reaction, for example, a gas or solid produced by the reaction. In embodiments where one or more solid products is produced, those products may be separated from the catalyst or catalytic system by exploiting their physical and/or chemical properties, such as hydrophobicity and/or density. For example, the solid product(s) may float to the surface of the catalyst or catalytic system, or may sink to the bottom of the catalyst or catalytic system, due to their different density and/or insolubility in the catalyst or catalytic system (including solvent), and may therefore be removed by mechanical means such as skimming or removed by the action of gravity through, e.g., a reactor outlet.

The method for catalysing a chemical reaction described herein may further include the step of recycling the catalyst or catalytic system. In particular, the method for catalysing a chemical reaction described herein may further include the step of recycling the liquid metal component of the catalyst or catalytic system, e.g., by allowing separation of the liquid metal droplets from the solvent. In this way, the liquid metal can be separated using gravity, for example, and resuspended in fresh solvent to conduct subsequent reactions.

In some embodiments, the catalyst or catalytic system of the present invention has a conversion efficiency of between about 1 to 100%, between about 1 to 99%, between about 20 to 99%, between about 20 to 30%, between about 70 to 99%, between about 80 to 99% or between about 90 to 99%.

### Reactions and Reactants

In one embodiment, the method for catalysing a chemical reaction described herein is a method for reduction of carbon dioxide to yield solid carbon and oxygen gas comprising (a) providing a catalyst or catalytic system as described in the foregoing section entitled “Catalyst or catalytic system” comprising liquid metal droplets dispersed in a solvent; and (b) contacting the catalyst or catalytic system with carbon dioxide. This reaction may be represented thus:

CO_{2(aq)}→C₍ₛ₎+O_{2 (g)}

The catalyst or catalytic system for this reaction preferably comprises a liquid metal catalyst or catalytic system comprising gallium and silver, preferably in the proportion of between 70-95% gallium and 30-5% silver by weight, between 85-95% gallium and 5-15% silver by weight, but other liquid metals may also be suitable. Solvents such as acetonitrile, water, glycerol, ethanolamine and dimethylformamide are particularly suitable for this reaction. In this embodiment, the chemical reaction is preferably assisted throughout contacting by application of ultrasound energy in the form of a sonication bath or wand. Although CO₂ is the reactant in this case, and it is envisaged that the reactant is provided to the catalyst or catalytic system in the form of bubbles of pure CO₂, or substantially pure CO₂, a reactant feed comprising CO₂ in combination with one or more other gases may be used. For example, mixtures of CO₂ and one or more of (di)nitrogen, (di)oxygen, water, oxides of nitrogen and/or sulfur, etc. may be provided. Such reactant feed mixtures may be derived from the exhaust generated through burning of fossil fuels, for example.

Without wishing to be bound by theory, the inventors contemplate that carbon-carbon bonds can be formed by breaking down CO₂ on the surface of the liquid metal droplets when CO₂ is injected into the catalyst or catalytic system. Overall, the outcomes show high efficiency and selectivity of carbon capture on the surface of liquid metal droplets from CO₂. An advantage of the method for catalysing this chemical reaction using the catalysts or catalytic systems described herein is that the reaction proceeds without the application of electrical current. Optional addition of electrical current to the catalyst or catalytic systems herein may increase the conversion rate.

As noted above, the chemical reaction in the methods described herein may be conducted in the presence of energy, such as mechanical energy in the form of rapid agitation or ultrasound energy such as supplied by a sonication bath or wand. In such embodiments, the liquid metal droplets in the catalysts or catalytic systems described herein are advantageously “self-cleaning” during catalysis as a new catalytic surface is continually generated by agitation of the droplets and the new catalytic surface is continually presented to the reactant(s). In this way, particularly with reference to the reduction of carbon dioxide to solid carbon and molecular oxygen, the catalysts or catalytic systems herein are resistant to coking.

In other embodiments, it is envisaged that other chemical reactions may be catalysed. For example, the catalyst or catalytic system of the present invention can catalyse the formation of graphene oxide, carbon doped nitrogen, oxygen or carbon monoxide formation. Generally speaking, it is envisaged that the reactant(s) may be provided to the catalyst or catalytic system for the methods of catalysis described here in any suitable form, including in pure form or in the form of a mixture with other components.

The methods for catalysing a chemical reaction described herein may further comprise the step of dissolving the reactant(s), or a reactant feed comprising the reactant(s) in combination with one or more other compounds, in a solvent prior to contacting the reactant(s) with the catalyst or catalytic system.

The catalyst or catalytic systems and catalytic reactions described herein may be conducted in any suitable apparatus and is therefore not limited to a particular setup or configuration. However, by way of example, the reaction may be conducted in a gas-liquid reactor (either adapted for continuous or semi-batch type reactions) and advantageously including a bottom diffuser, or in a bubble column reactor. Such reactors may include a mechanical agitator (in embodiments where the liquid metal droplets are dispersed using mechanical agitation methods) or may alternatively include means to facilitate delivery of ultrasound energy, such as an ultrasound wand, or a cavity subject to ultrasound energy, for example. Other suitable reactor designs will be apparent to those of skill in the art and may depend on the state of the reactant(s) and product(s) formed.

In other embodiments, the method for catalysing a chemical reaction described herein is a method for reduction of methane to yield solid carbon and hydrogen gas comprising (a) providing a catalyst or catalytic system as described in the foregoing section entitled “Catalyst or catalytic system” comprising liquid metal droplets dispersed in a solvent; and (b) contacting the catalyst or catalytic system with methane. This reaction may be represented thus:

CH_{4(aq)}→C₍ₛ₎+H_{2 (g)}

In some embodiments, the method for catalysing a chemical reaction as described herein is a method for reduction of carbon dioxide and methane in one-pot.

### EXAMPLES

The present invention will now be described with reference to the following examples which should be considered in all respects as illustrative and non-restrictive.

### Materials

Gallium (Ga, ingot, purity: 99.99%), and silver powder (purity: 99.9%) was used. All the salts, including AgF, AgCl, AgBr, AgI, AgOTf, AgNO₃, KCl, NaCl and NaHCO₂, were used with a purity of 99.5%. The solvents dimethylformamide (DMF) (purity: 99.8%, boiling point: 153° C.), ethanolamine (ETA) (purity: ˜98%, boiling point: 170° C.) and HCl (33 wt % in water) were used. Nitric acid (acidimetric: ≥65.0%), 5,5-dimethyl-1-pyrroline N-oxide (DMPO, 99.9%) and H₂O₂ (30 wt % in water) were used. Milli-Q ultrapure water was used throughout the experiments for sample preparation and reaction.

### Sample Characterisation

Raman spectra were collected via a Raman spectrometer (Via Raman microscope, Renishaw) utilising a 532 nm laser source. XPS was performed on a Thermo Scientific K-alpha X-ray spectrometer. The carbon product was studied using micro-FTIR spectroscopy, on a PerkinElmer Spectrum 100 FTIR Spectrometer which is coupled to a Spotlight 400 FTIR Imaging System with stage controller. The morphology and structure of materials were imaged by SEM (JEOL JSM-IT-500 HR). The TEM and SAED characterisations were performed on a Phillips CM200 TEM system. Both the SEM and the TEM systems are coupled with an EDS detector for elemental and compositional analysis. The crystalline phases of the samples were characterised by XRD (Philips X'Pert Pro MPD, λ=1.54 Å, Cu-Kα radiation). The TGA for carbonaceous material quantification was performed on a Thermogravimetric Analyzer TGA Q5000 IR. ICP-MS was performed on NexION 2000 B ICP Mass Spectrometer to determine the concentration of gallium and silver ions. EPR experiments for the detection of the CO₂^{⋅-} radicals were conducted on a Bruker EMX X-Band ESR Spectrometer (Bohr). NMR experiments were performed to investigate the liquid species in the solution, which was performed by using Bruker Avance III 600 MHz Cryo NMR (Ernst).

### Preparation and Analysis of Tga Samples

The carbonaceous materials for the TGA experiments were separated by centrifugation. After a certain reaction time (T, h), the homogeneous mixture from the reactor (2.0 mL) was added into a centrifuge tube followed by centrifuging at a speed of 100000 rpm for 10 min. During this process, the suspended solid materials were separated into different layers. Most of the metallic catalysts deposit at the bottom of the tube due to their high density, in comparison to the carbonaceous materials which remains suspended in the top layer. The centrifugation process was repeated three times and each time the carbon-containing top layer was collected. The collected materials (sample volume VTGA=2.0 mL solution during certain reaction time T (h)) were then dried (110° C.) to remove DMF from the samples before the TGA experiments. During the TGA experiments, the heating rate was set to 10° C./min and the upper temperature limit was fixed at 800° C.

### ICP-MS Samples

During the process of CO₂ reduction, 1.0 mL reaction mixture was taken as a sample every hour and then we centrifuged the sample for 15 min at 100000 rpm until all the suspended materials deposit at the bottom of the tube. Then, 0.20 mL clear solution from the top of the sample was taken and heated on the hot plate until it was completely dried. Thereafter, 0.20 mL of nitric acid was added to dissolve the residue for ICP-MS.

### Cyclic Voltammetry Experiments

Cyclic voltammetry experiments were conducted to investigate the roles of the Ag_{0.72}Ga_{0.28} rods during the CO₂ reduction. Ga droplets and Ag_{0.72}Ga_{0.28} rods were obtained from the Ga and AgF precursors. Then, Ga/Ag_{0.72}Ga_{0.28} (Ag_{0.72}Ga_{0.28} in the shape of rod) was painted on fluorine doped tin oxide (FTO) and baked until the material dried and immobilised on the FTO as the working electrode. A calomel reference electrode and a gold counter electrode was used to set up a three-electrode configuration. DMF+ETA solution containing 0.10 M HCl was utilized as the electrolyte to keep the condition consistent to the reaction situation. As a comparison, Ga droplets and Ga/Ag_{0.72}Ga_{0.28} (Ag_{0.72}Ga_{0.28} with non-rod morphology, using Ga/AgI) were painted on FTO as the working electrode respectively and all other parameters were kept identical.

### EPR Experiments

To provide mechanistic insights, EPR experiments were conducted to confirm the existence of the activated CO₂. DMPO is known as a standard CO₂ radical captor and the combination of DMPO with the CO₂ radical shows characteristic signals. During the experiments, 20 mg DMPO was added and dissolved into 5.0 ml Milli-Q water and then 1.0 mL DMPO solution was further added into the reaction system. After bubbling CO₂ into the solution in the presence of bath sonication for 30 min, 1.0 mL reaction solution was centrifuged to remove all the suspended materials for EPR measurement. As a control, 1.0 mL DMPO solution was added into the reaction system in the process of bath sonication without bubbling CO₂.

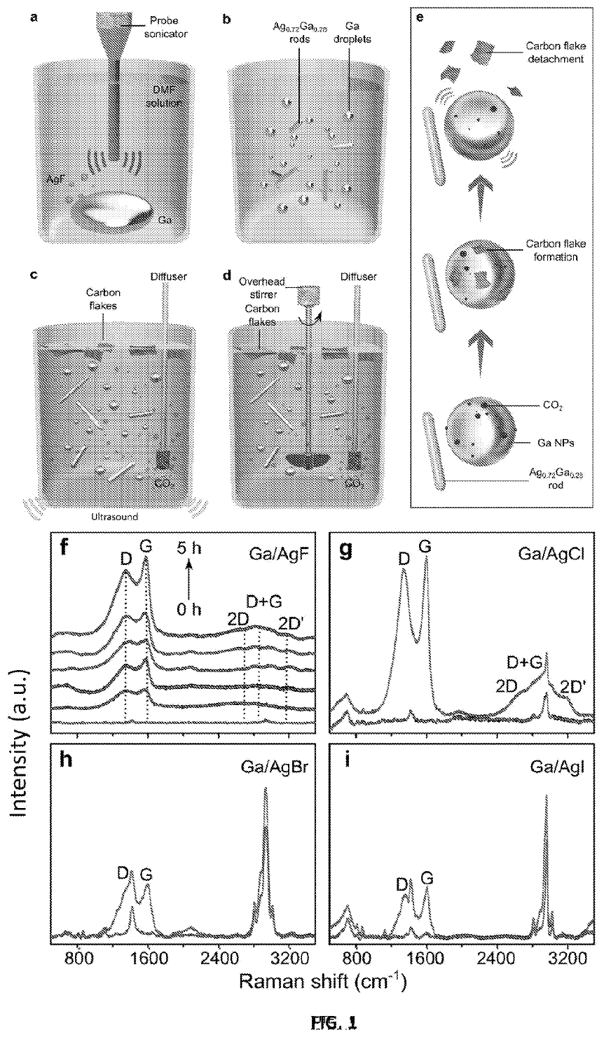

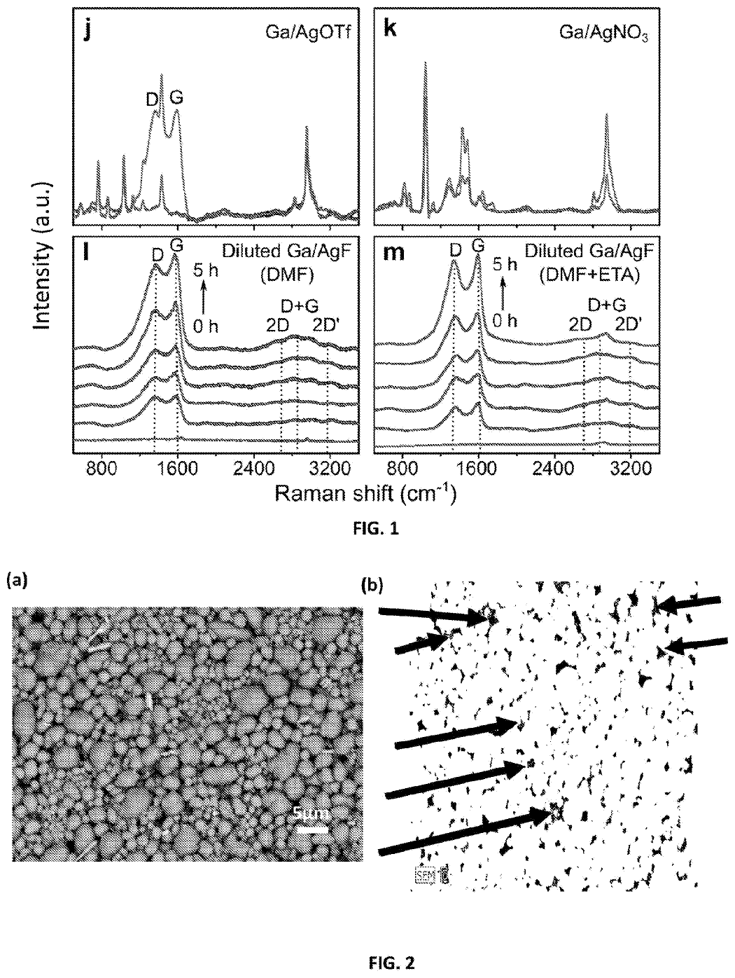

To verify that the EPR signal obtained from our reaction system was due to the formation of CO₂^{⋅-}, an independent reaction involving CO₂^{⋅-} formation is further conducted. It is well established that the CO₂^{⋅-} radical can be generated from NaHCO₂ and H₂O₂ under the irradiation of ultraviolet light. NaHCO₂ and 30% H₂O₂ were dissolved in 5.0 mL Milli-Q water in the concentration of 100 mM and 100 μM, respectively, with the DMPO concentration being 50 mM DMPO. After irradiation with ultraviolet light for 10 min, we mixed 1.0 mL photolytic solution with 20 mL DMF solution for EPR analysis to keep the condition consistent with the conditions of our CO₂ conversion reaction. By comparison, the EPR spectra from the reaction system and photolytic solution were in good agreement, thereby validating the existence of CO₂^{⋅-} radical during CO₂ conversion reaction as shown in FIG. 1c.

### Example 1: Gallium Based Liquid Metal Catalysis

Certain metal catalysts could significantly lower the energy barrier of CO₂ reduction, and provide promising CO₂ conversion.

The very low melting point transition metal of choice is gallium (melting point of about 29.8° C.). The catalysts and catalytic systems comprising Gallium(I) have a combination of the triboelectric effect and electrochemical reaction to convert the reagents. Surprisingly, this lowers the energy required to convert the reagents using the catalysts and catalytic systems described herein. However, gallium(I), is not commercially available because it is unstable under normal conditions. The present Applicant has provided gallium(I) through oxidation of gallium(0) by silver(I). Gallium(I) provides C—C bond formation through CO₂ reduction.

The present invention uses suspensions of gallium (Ga) liquid metal to reduce CO₂ into solid carbon and molecular oxygen, at about room temperature. The non-polar nature of the liquid gallium interface allows the solid products to naturally exfoliate. This allows ‘active’ sites of the gallium liquid metal to be accessible and free from deactivation by poisoning. In some embodiments, a solid intermetallic phase of Ag_{0.72}Ga_{0.28} in the shape of a rod forms when the catalyst or catalytic system is prepared with a silver salt. The intermetallic phase of Ag_{0.72}Ga_{0.28} present in the catalyst or catalytic system of the present invention can allow a cyclic catalytic process (alternating between Ga(0) and Ga(I)) which allows continuous catalysis. The catalyst or catalytic system is formed when energy is applied which drives the triboelectrochemical reactions.

The application of energy such as sonication, agitation, stirring and the like to the liquid metal and/or catalyst system can increase the interfacial temperature of the catalyst or catalytic system and generate triboelectrification, as a result of the frictional contact and modulation of gaseous content solubility.

The present inventors have shown that Gallium (Ga)-based liquid metals have improved properties for catalysis, including tunability by the incorporation of other elements, and remarkable resistance to coking and also mechanical tolerance. The present inventors have found that using liquid metal mixes of Ga and silver or a silver salt can in some embodiments provide a closed cyclic catalytic system—that is the two oxidation states of Ga(0) and Ga(I) can be cycled between the two states without external stimuli or additives (i.e., oxidation of Ga(0) to Ga(I) by AM for carbon dioxide reduction; and regeneration of Ga(0) by reduction of Ga(I) due to an intermetallic phase such as Ag_{0.72}Ga_{0.28}).

### Step A: Preparation of the Catalyst or Catalytic System

A liquid metal alloy of silver-gallium (1:10, 1:5 or 1:2) which is liquid at room temperature was prepared by co-melting and/or co-grinding. The liquid metal alloy was then added to a container filled with dimethylformamide solvent as a 50% w/w alloy in solvent (alloy density 10% v/v and 90% v/v solvent) and the mixture was sonicated in an ultrasound bath (ultrasound frequency at 50 kHz) for 10 min.

Hydrochloric acid (0.1 M) was added to the liquid metal and solvent mixture.

An electron microscopy image of the catalyst thus formed is shown in FIG. 2(a), reflecting that liquid metal droplets of sub-micron sizes are formed after agitation for 10 mins.

### Step B: Reaction—Reduction of Carbon Dioxide

Under RTP conditions (˜25° C. and ˜1 atm), CO₂ gas was injected by pipette into the catalyst formed in Step A above with continuous sonicating.

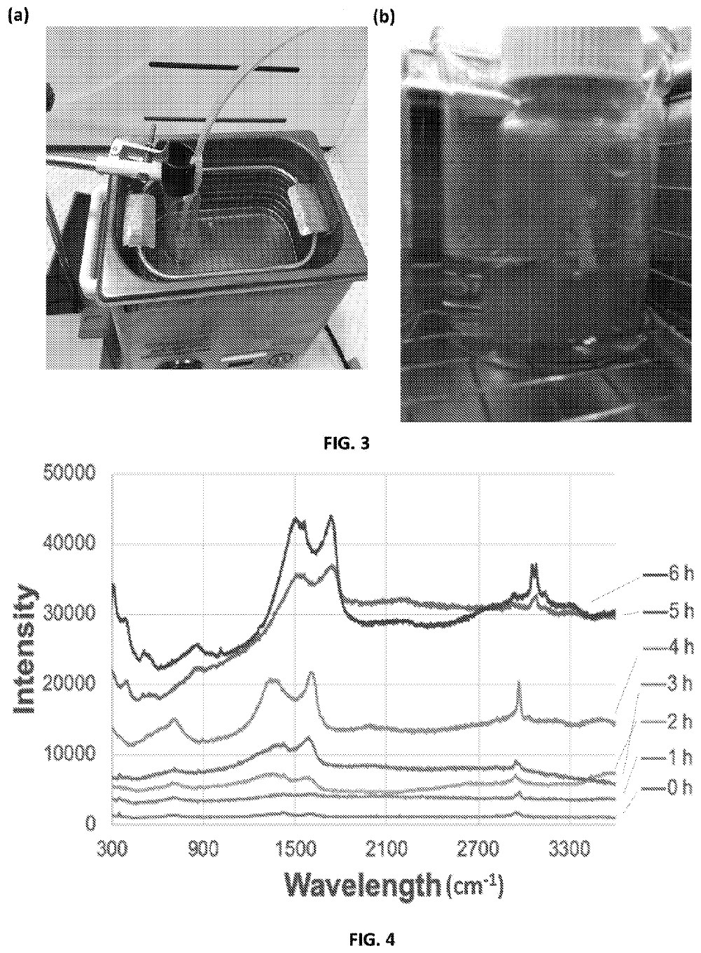

The set-up of the system is shown in FIG. 3. The successful transformation of liquid metals into dispersed liquid metal droplets and the production of solid after CO₂ injection fora period of 5 hours is shown in FIG. 2(a). Raman spectrum peaks at 1360 and 1590 cm⁻¹ in FIG. 4 reflect the presence of carbonaceous material (i.e., solid carbon) after reacting CO₂ with the catalyst of Step A. Carbonaceous material is produced under ultrasound for 5 hours which is visibly observable to the naked eye. During the catalysis reaction, the dissolved CO₂ in the solvent is catalysed by the suspension of liquid metal (such as micro and nano) droplets.

The value-added products from CO₂ conversion can be of gaseous, liquid and solid in nature, depending on the alloy mixture, mechanical agitation, temperature and the solvent used. One desired by-product is solid material made after C—C bond formation. C—O bonds are broken on or near the surface of liquid metals and C—C bonds are formed. Due to the ultra-smooth nature of liquid metals these materials are produced as sheets.

These solid carbon sheets, which are formed on the surface of liquid metals, detach themselves during the mechanical agitation and do not cause coking, allowing catalytic reaction to continue. Additionally, the surface of liquid metals is not polarised, so the carbon sheets have minimal adhesion to the surface. Carbon sheets can be separated due to their density difference from liquid metals. These carbon sheets have been shown to be graphene oxide by the Applicant as described in Example 4.

### Alternate Method for Preparation of Catalyst

(1) Sliver salts as precursors: During a typical co-contributor preparation process (using AgF as an example), Ga (7.0 g) was first added into a glass vial which is pre-filled with 5.0 mL DMF solution, followed by adding HCl solution to give a final 0.10 M to remove the surface oxide layer of Ga. AgF (1.0 g) was then added to the mixture as the precursor.

(2) Ag (150 nm particle size) as precursors: For the preparation of Ag—Ga alloy, silver powder was added to Ga (7.0 g) in concentrations of 2.0 wt % and 5.0 wt %, respectively. The mixtures were ground using a mortar and pestle inside a nitrogen-filled glove box to minimize oxidation of the liquid metal. The grinding process, typically lasts 40 min, was stopped when the sample showed a smooth and reflective appearance.

(3) Probe sonication procedures: The mixture from step (1) or step (2) was sonicated with a probe sonicator (VC 750, Sonics & Materials) under the protection of nitrogen. The sonication amplitude was set to 55%, corresponding to an ultrasonic power input of ˜410 W. The sonicator was paused for 1 s after each 9 s sonication and the total sonication time was 30 min.

### Alternate Method for Reduction of Carbon Dioxide

(1) Bath sonication as the energy source: After the alternative method for preparation of the catalyst, CO₂ was bubbled into the reactor through a diffuser and the flow rate of CO₂ gas (10 sccm; standard cubic centimetres per minute) was controlled using a gas mass flow controller (MKS, GE50A). Bath sonication (FREQ 50 Hz, Unisonics) was employed as the mechanical energy source to trigger CO₂ conversion. The temperature of the reaction solution was kept around 40° C. during the 5 hours reaction.

(2) Overhead stirrer as the energy source: When CO₂ was bubbled into the reactor through a diffuser at the same rate of 10 sccm, an overhead stirrer (DLS Digital Overhead Stirrer, 120 W) was utilized as the mechanical energy source. Different rotation speeds, including 200, 300, 400, 500 and 1000 rpm, were applied for initiating the CO₂ conversion. The experiment was performed at room temperature for 24 hours.

### Example 2: Structure of Metal Catalysts

Structure and size are two important parameters of metal catalysts, which can greatly affect the properties of materials. For producing gallium(I) through oxidation of gallium(0) by silver(I), efficient active sites between gallium(0) and silver(I) are important. Also, access to efficient active sites is an important consideration for CO₂ reduction. In order to enhance the active sites, the Applicants decrease the size of gallium particles through sonication. Gallium as the liquid metal can simultaneously prevent the coking of active sites by natural exfoliation of the solid by-products from C—C bond formation, improving the durability of the catalyst.

To the Applicants' knowledge, sonication has not been used as input energy to activate CO₂ conversion. Sonication can also increase the reaction efficiency between gallium(0) and silver(I) to provide greater gallium(I) yield due to improved mixing. Further, sonication increases the surface-to-volume ratio of the liquid metal as the liquid metal is placed under high shear forces during sonication which results in micro, sub-micro and/or nano droplets and thereby provides more active sites for catalysis.

### Example 3: CO₂ Conversion Using Mini Reactor

A mini reactor containing 7 g of gallium, 1 g of AgCl, 5 ml of dimethylformamide (DMF) as the solvent and 0.1 M of HCl was provided. Gallium and AgCl were added into the DMF together for forming gallium(I), and HCl was then used to remove the gallium oxide. The setup is shown in FIG. 3. The catalysts were prepared and used using Steps A-B described in Example 1.

The solution was sonicated for 30 min and after sonication, CO₂ was introduced into the solution by a diffuser during the bath sonication for about 6 hours. A sample was taken each hour and analysed using Raman spectrometry as shown in FIG. 4.

Raman spectroscopy confirmed CO₂ reduction. As shown in FIG. 4, the characteristic peaks of solid carbon, at 1360 and 1600 cm⁻¹ were observed and increased as the reaction continued.

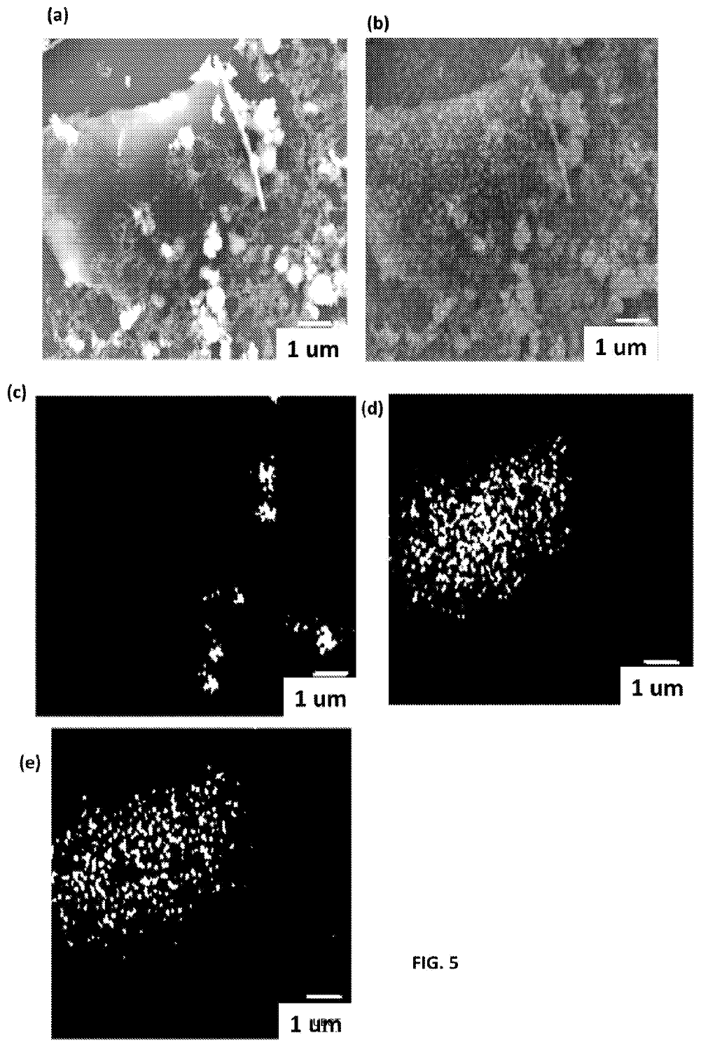

Solid carbon was also confirmed by scanning electron microscopy (SEM) and energy-dispersive X-ray spectroscopy (EDS), as shown in FIG. 5. The presence of nitrogen is due to the fact that CO₂ was introduced together with nitrogen. The carbon doped nitrogen by-product is valuable as it can be used as a battery electrode.

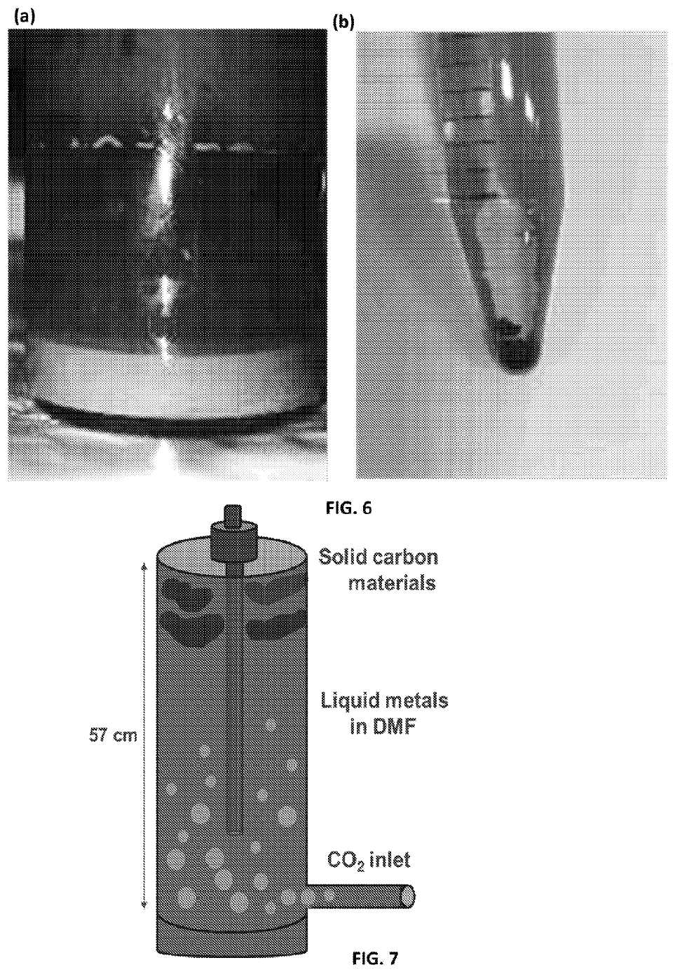

Carbonaceous material was produced after 5 hours of reaction as shown in FIG. 6.

### Example 4: Large Scale CO₂ Conversion

A large-scale CO₂ conversion system is shown in FIG. 7. This system can provide continuous CO₂ scrubbing. The optimal height ˜0.57 cm and 0.25 m of diameter is sufficient to achieve no CO₂ release (i.e., complete CO₂ conversion). The system scrubs 1 litre of CO₂ from 400 cc/min input and generates approximately −12 g of C per hour. The Applicants have shown that traces CO is also found in the headspace. However, the main by-products are graphene oxide (solid) and oxygen (gas). The catalysts or catalytic systems were prepared and used using Steps A-B described in Example 1.

Although the invention has been described with reference to specific examples, it will be appreciated by those skilled in the art that the invention may be embodied in many other forms in particular features of any one of the various described examples may be provided in any combination in any of the other described examples.

### Example 5: Assessment of CO₂ Conversion Using Catalysts or Catalytic Systems of Catalytic Metal Salts

The Applicant used a suspension of Ga and Ag (I) salt mixes as precursors to form a catalyst comprising a liquid metal and a co-catalyst (co-contributor) in the form of an intermetallic phase Ag_{0.72}Ga_{0.28}. The catalysts were prepared using the alternative methods described in Example 1. Ultrasound was used to for CO₂ reduction. Dimethylformamide (DMF), has good stability during mechanical agitation and high CO₂ solubility of 0.14 M at 40° C. (to ensure that Ga is in liquid state). As such, DMF was used as solvent. The inventors observed that during the catalytic reaction, CO₂ molecules near the interface of the dispersed liquid metal particles in a solvent were reduced to form solid carbon sheets.

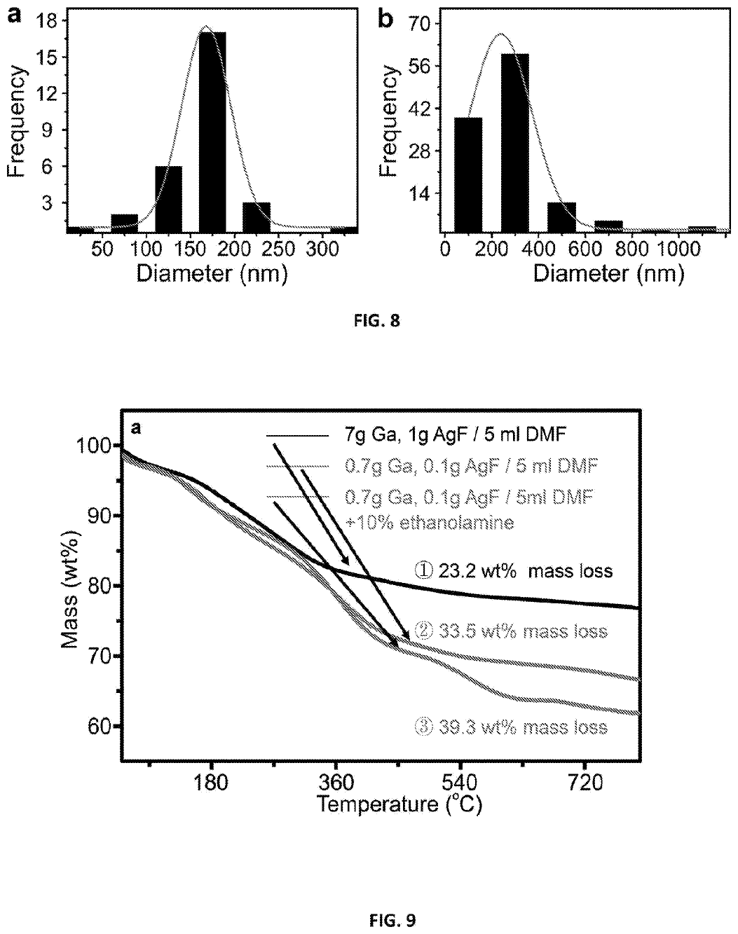

The optimum results were obtained when Ga and AgF were mixed in a DMF solution which also contained 0.10 M HCl to remove the native oxide on the surface of Ga. Ga and AgF were sonicated together (as shown in FIG. 1a—using a probe sonicator for 30 min) to generate sub-micron Ga droplets of 230 nm median diameters and Ag_{0.72}Ga_{0.28} rods of micron/sub-micron lengths and median diameters of 160 nm (as shown in FIG. 1b and FIG. 8).

In the reactor, CO₂ was bubbled into and dissolved in DMF through a diffuser as shown in FIG. 1c. The dissolved CO₂ is reduced to solid carbon materials at the interface of the Ga droplets. The mechanically enforced CO₂ conversion can be scaled up using a variety of mechanical sources that produce frictional contact. CO₂ conversion was also performed using an overhead mixer as shown in FIG. 1d.

Due to the ultra-smooth nature of the liquid metal droplets, the produced carbon materials on the surface are in the form of sheets. These low dimensional sheets, on the non-polarized liquid metal surface, are exfoliated during mechanical stimulation as shown in FIG. 1e. Most importantly, the carbon sheets migrate to the top of the reactor and can be isolated due to the density difference with reference to that of metallic components (i.e., liquid metal droplets as shown in FIGS. 1c and d).

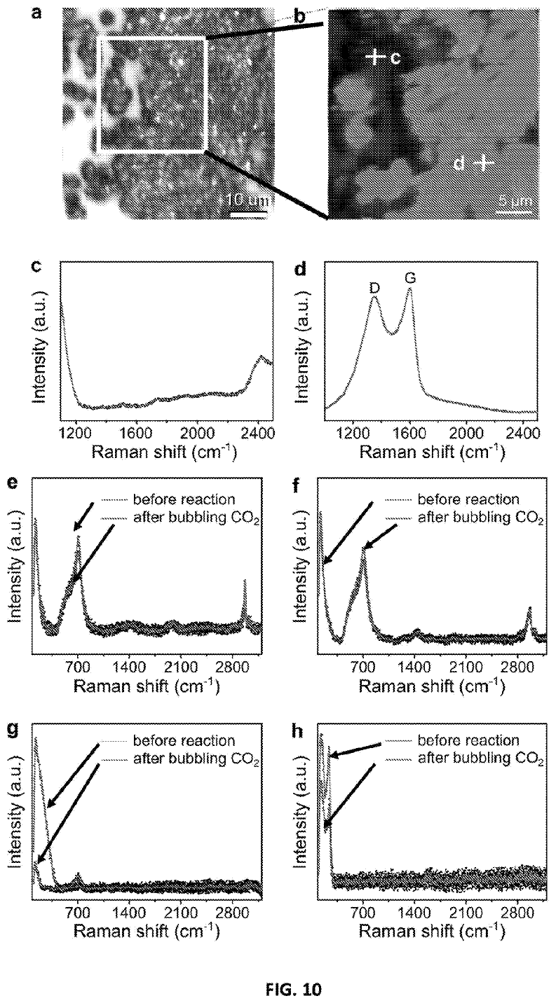

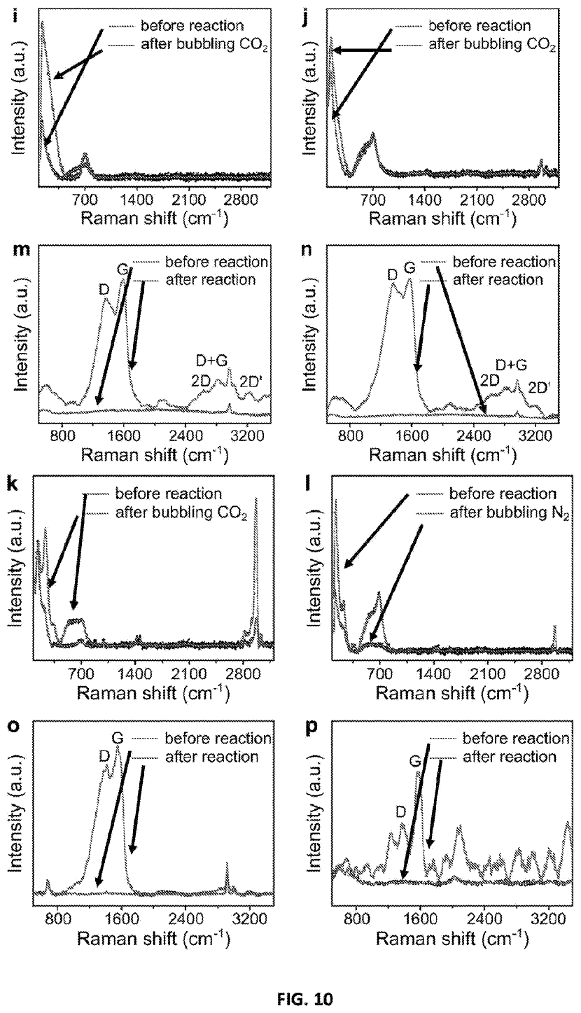

The qualitative and quantitative analyses of the production of carbon, when the Ga/AgF (7.0 to 1.0 mass ratio) suspension in DMF is utilized in a 20 ml reactor, are shown in Figure if and FIG. 9. The 7.0 to 1.0 mass ratio and the reaction temperature were chosen according to previously optimized data for C—C bond formation reactions. Additionally, the performance of the catalyst formed by direct alloying of Ga with silver (50 to 1.0 or 20 to 1.0 mass ratio of Ga/Ag, shown in FIGS. 10e and f) and different silver salts (FIG. 1g-k), including AgCl, AgBr, AgI, AgOTf, AgNO₃ (also 7.0 to 1.0 mass ratio) were compared. The homogeneous mixture (20 μL) was drop-casted onto a glass substrate and dried for Raman analysis, with the whole drop-cast region included during the Raman spectroscopy measurement (as shown in FIG. 10a-d). The changes in the intensity of the carbon D and G bands at 1350 and 1600 cm⁻¹ were analysed. Thermal gravimetric analyses (TGA) and gas chromatography (GC) were also conducted for comparative quantitative assessment of the solid carbon and gaseous products as shown in Table 1.

TABLE 1
Capture and conversion of CO₂ under different configurations and scenarios.

| | | Volume | Height | | | | Volume of | Volume of | Produced | |
|---|---|---|---|---|---|---|---|---|---|---|
| CO₂ | | of the | of the | | | | CO₂ in the | CO₂ in the | solid | Conversion |
| conversion | | reactor | reactor | Reaction | CO | O₂ | input | output | carbon | efficiency |
| setups | Solution ⁽¹⁾ | (mL) | (cm) | time (h) | (cm³/h) | (cm³/h) | (cm³/h) ⁽²⁾ | (cm³/h) | (mg/h) | (%) |
| Bath | DMF | 20 | 4.5 | 5 | 0 | 1.2 | 600 | 591 | 4.75 | 1.5% |
| sonication | DMF | 500 | 40 | 1 | 0 | 15.5 | 516 | 377.5 | | 26.8% |
| | | 500 | 40 | 3 | 0 | 75.5 | 516 | 375.5 | | 27.2% |
| | | 500 | 40 | 6 | 0 | 79 | 516 | 371.5 | 160 | 28% |
| | 90% DMF + 10% ETA | 20 | 4.5 | 5 | 22.2 | 0.36 | 600 | 563 | 7.95 | 6.2% |
| | 90% DMF + 10% ETA | 330 | 27 | 5 | 13 | 50.5 | 480 | 0 | | 100% |
| | | 330 | 27 | 12 | 15 | 58.5 | 480 | 0 | | 100% |
| | | 330 | 27 | 24 | 0 | 120.5 | 480 | 40.5 | | 91.5% |
| | | 330 | 27 | 30 | 0 | 210.5 | 480 | 38.7 | 360 | 92% |
| Stirring at 300 | 90% DMF + 10% ETA | 50 | 3.0 | 24 | UM | UM | 600 | UM | 3.65 | UM |
| rpm | | | | | | | | | | |
| Stirring at 400 | 90% DMF + 10% ETA | 50 | 3.0 | 24 | UM | UM | 600 | UM | 5.95 | UM |
| rpm | | | | | | | | | | |
| Stirring at 500 | 90% DMF + 10% ETA | 50 | 3.0 | 24 | UM | UM | 600 | UM | 7.45 | UM |
| rpm | | | | | | | | | | |
| Stirring at | 90% DMF + 10% ETA | 50 | 3.0 | 24 | UM | UM | 600 | UM | 9.45 | UM |
| 1000 rpm | | | | | | | | | | |

Note:
⁽¹⁾ The concentration of co-catalysts was 0.14 g/mL gallium and 0.020 g/mL AgF, respectively.
⁽²⁾ The flow rate of CO₂ bubbling was set at 10 sccm (The actual flow rate of CO₂ in the scaled-up reactors was ~8.6 and ~8.0 sccm in DMF and DMF + ETA cases, respectively, owing to the pressure and the viscosity of the solvent).

For the Ga/AgF system that exhibited the best performance, the production of carbon was observed in <1 hour of reaction (as shown in FIG. 10 and increased continuously overtime according to TGA. The TGA showed that 4.95 mg of carbonaceous materials were produced per hour in a 20 mL reactor at the flow rate of ˜9.8 sccm (as shown in FIG. 9). In comparison, the AgCl, AgBr, AgI, and AgOTf mixes also presented CO₂ conversion capability, but they were not as efficient as the AgF system (as shown in FIG. 1g-j, for brevity only Raman spectra are shown and not TGA). With no emerging D and G bands after 5 hours of reaction (as shown in FIG. 1k and FIGS. 3e and f), the combination of Ga/AgNO₃ and Ga—Ag alloys (from silver metal) were less effective for CO₂ reduction. Optimising the reaction conditions such as temperature and/or increased duration of Ga/AgNO₃ and Ga—Ag may increase the catalytic efficiency. However, as would be appreciated in the art, different combinations of liquid metals and/or catalytic metals and alloys thereof as described herein may be suitable as catalysts of the present invention.

The present inventors surprisingly found that catalysts formed using gallium and a silver salt such as AgF, produced a synergistic catalyst suitable for reducing reactants such as CO₂ and methane. Experiments were performed using Ga and AgF separately (as shown in FIGS. 10g and h), both of which resulted in minimal carbon production. Other types of salts (e.g. KCl and NaCl) (as shown in FIGS. 10i and j) and magnetic stirring (less powerful in comparison to ultrasonication and overhead stirring) (as shown in FIG. 10k), showed minimal carbon formation, indicating the use of a silver salt (AgF) and a sufficient mechanical energy input (such as sufficient stirring above about 200 rpm and sonication) can improve catalytic conversion efficiency and synergy. Controlled N2 bubbling also did not show any formation of products (as shown in FIG. 10l).

The inventors also studied the minimum co-catalyst mass required in the system to maintain sufficient conversion efficiency of CO₂. Diluting the material by 10 times offered nearly the same conversion efficiency, still achieving an equivalent production of 4.75 mg of carbonaceous materials per hour at 9.85 sccm CO₂ bubbled (as shown in FIG. 1l and FIG. 9), whereas the output was dramatically reduced for dilutions of 50 or 100 times (as shown in FIGS. 10m and n. TGA profiles are not shown for brevity).

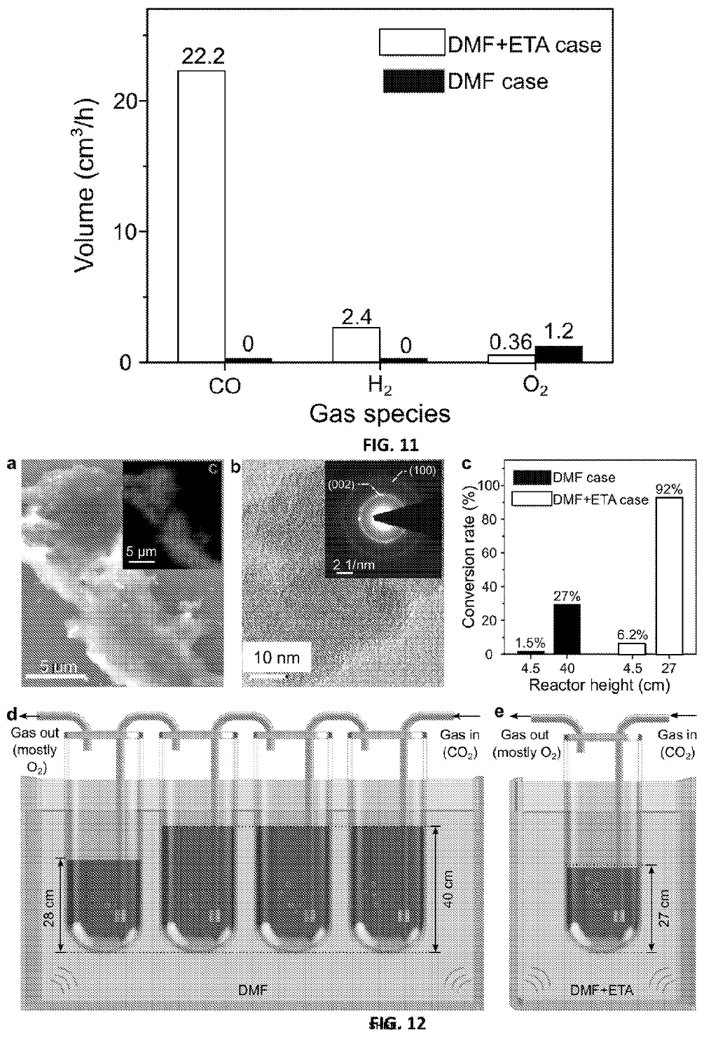

The amount of CO₂ dissolved in solution also significantly influenced the conversion efficiency of CO₂. ETA is a suitable choice for increasing the amount of reactant (such as CO₂) dissolved because CO₂ solubility is 5.6 M in pure ETA in comparison to 0.14 M in DMF at 40° C. With the addition of 10% ETA in DMF (DMF+ETA), CO₂ was continuously reduced to solid carbon and oxygen with a higher efficiency, producing 7.95 mg of solid carbon per hour in the same reactor at 9.38 sccm CO₂ bubbled (as shown in FIG. 1m and FIG. 2). Interestingly, 22.2 cm³ CO was also produced in one hour (as shown in FIG. 11). In contrast, when DMSO or H₂O were used, the efficiency was lower and carbon products was lower than the detection limit of TGA equipment used, owing to the limited CO₂ solubility (as shown in FIGS. 10o and p).

By altering the solvent (such as DMF and ETA) and change of the reactor height, the rate of the dissolution and conversion can be tuned. In one embodiment, the measured reactor height was 27 cm (90% dimethylformamide and 10% ethanolamine as the solvent and Ga/AgF (7:1) as the reaction material at CO₂ input of ˜8 sccm) for the conversion of CO₂ into O₂ and solid carbon material was converted at 92% conversion efficiency which is equivalent to a low input energy of 228.5 kW·h for the capture and conversion of a tonne of CO₂.

### Example 6: Carbon Material Characterisation

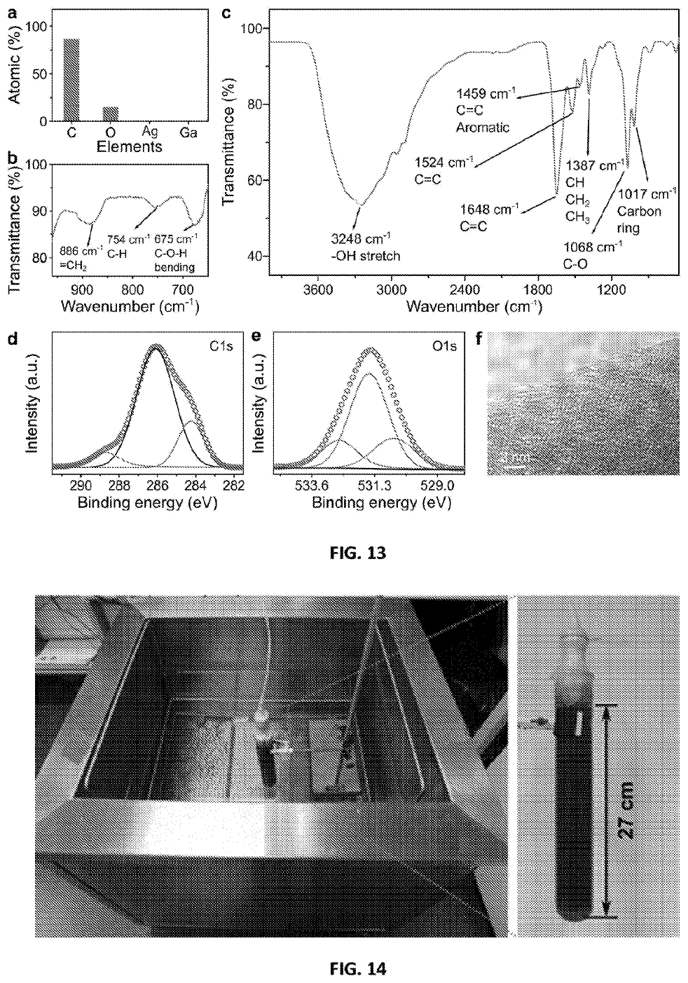

Solid carbon materials (carbonaceous materials) produced from the reduction of CO₂ by the catalysts of the present invention were isolated for further characterisation from Example 5. Scanning electron microscopy (SEM) and energy-dispersive X-ray spectroscopy (EDS) analysis (as shown in FIG. 12a and FIG. 13a) of the isolated carbonaceous materials reveal that the solid product comprises carbon and a small amount of oxygen before any secondary washing, with trace quantities of the metallic species that can be easily removed. Fourier transform infrared (FTIR) spectroscopy (as shown in FIGS. 13b and c) further confirmed that the solid carbon material primarily comprised of C═C and C—O bonds. Based on X-ray photoelectron spectroscopy (XPS) analysis, the C1s region of the carbonaceous materials shows characteristic peaks of sp₂ carbon and C—O bonding, at 284.2 and 286.1 eV, respectively (as shown in FIG. 13d). The presence of C—O bonds is confirmed from the 01s XPS region of the sample (as shown in FIG. 13e). As such, the likely by-product is highly oxidised carbon material of the ratio of 2:1 (carbon material:oxidised carbon material). Transmission electron microscopy (TEM) and selected area electron diffraction (SAED) images demonstrate that part of the carbonaceous material is akin to that of slightly crystalline graphene oxide (as shown in FIG. 12b), and a certain proportion of the product exists in the amorphous state (as shown in FIG. 13f).

### Example 7: Efficiency and Energy Requirement for CO₂ Conversion

The CO₂ conversion efficiencies of catalysts described in Example 5 in this were determined using TGA and GC measurements as summarised in Table 1. The conversion efficiency is defined as (captured and reduced CO₂/total input CO₂)×100, which were determined using an optimum ratio of Ga/AgF as described in Example 8.

In the small reactor of volume of 20 mL and height of 4.5 cm (as used for Examples 5 and 6), the conversion efficiencies are 1.5% and 6.2%, for DMF and DMF+ETA solvents, respectively as shown in FIG. 12c. To demonstrate the scalability, the present inventors increased the dimensions of the reactor as shown in FIG. 12d,e. When the height of the reactor was increased to 40 cm for only DMF solvent (vol of 500 mL), 27% of the input CO₂ at the flow rate of 8.6 sccm could be continuously captured and converted (as shown in FIG. 2c). When the total height of the reactor was 148 cm (as shown in FIG. 2d, four reactors in series), the CO₂ conversion could reach the full capacity.

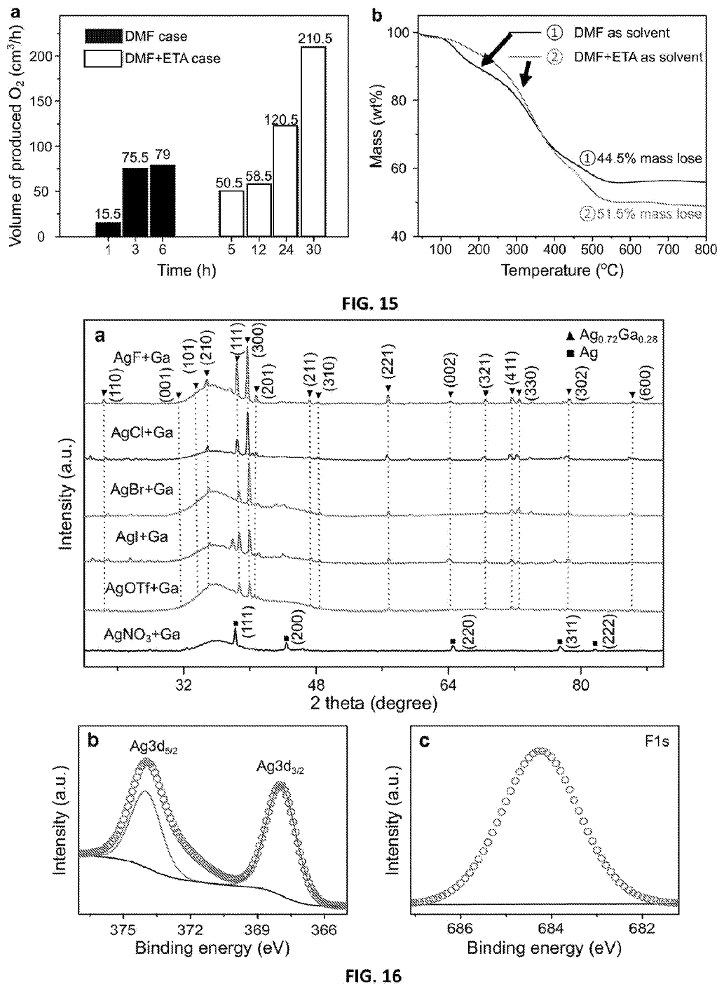

As we previously shown this height could be significantly decreased when DMF+ETA used at the solvent as this combination could significantly increase the CO₂ solubility. The conversion efficiency reached a conversion efficiency of 92% (at a flow of 8.0 sccm CO₂) for a reactor as small as 27 cm in height and 330 mL volume (as shown in FIG. 12c and FIG. 14 showing photographic image of the set-up). The amount of produced oxygen gas and carbon (highly oxidised carbon), under different conditions, are shown in FIG. 15 and Table 1.

According to these measurements, the total energies required for converting 1.0 tonne of CO₂, for DMF and DMF+ETA cases, were calculated to be 699.5 kW·h and 228.5 kWh, respectively (as shown under the heading “Estimation of the energy consumption”. An overall estimation based on the current price of electricity suggests that the operational cost of CO₂ capture and conversion using DMF+ETA is lower than any other state-of-the-art technologies.

### Example 8: Analysis of Suspensions

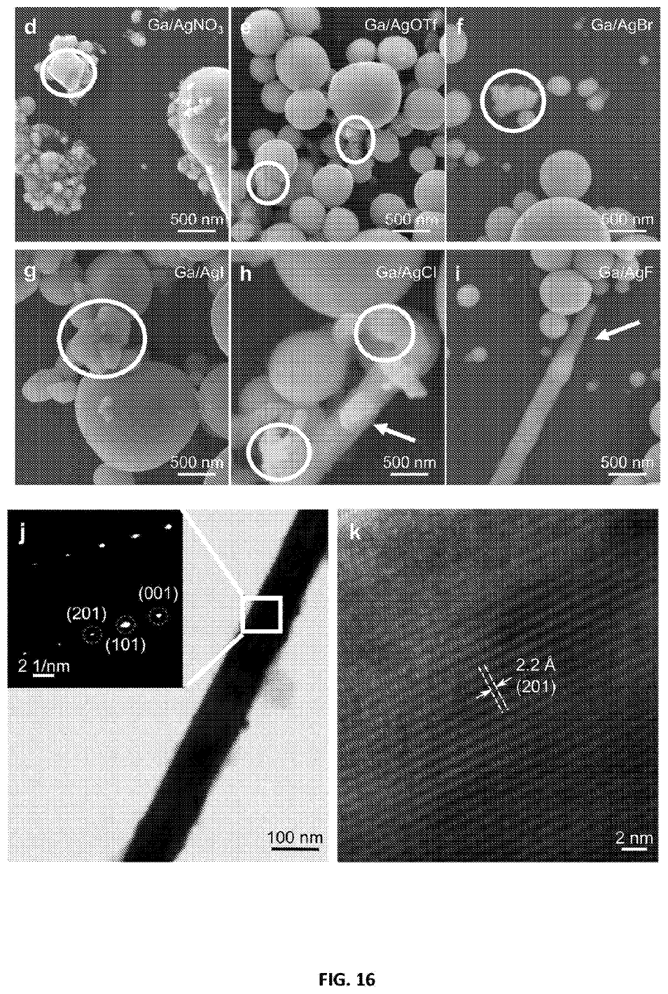

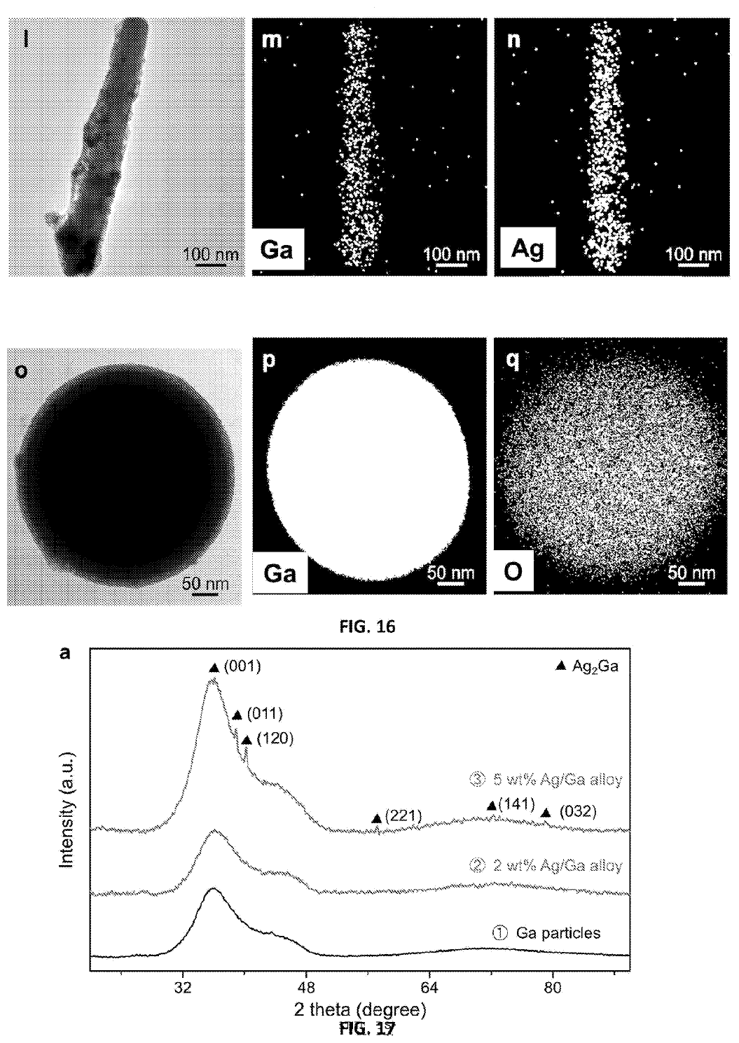

The reactions between Ga and silver salts of Example 5 were investigated by characterising the sonication products. Sonicating Ga with AgF (as an exemplary embodiment) showed the presence of an intermetallic phase Ag_{0.72}Ga_{0.28} (as shown in FIG. 16a) and GaF₃. The presence of intermetallic Ag (in the form of Ag_{0.72}Ga_{0.28}) was confirmed by the Ag₃d XPS peaks at 367.8 and 373.8 eV (as shown in FIG. 16b). The metallic fluorides were verified by the F1s XPS peak at 684.3 eV (as shown in FIG. 16c).

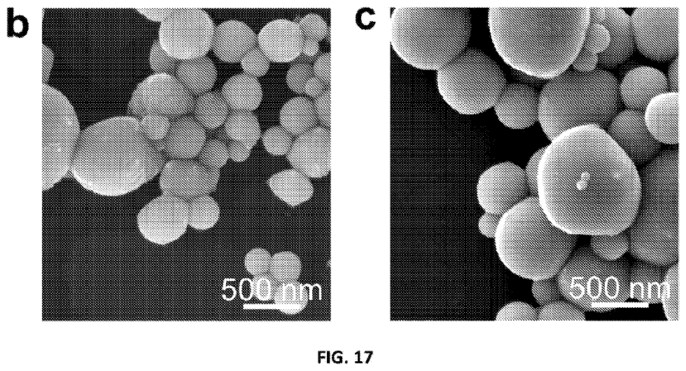

The compositions and morphologies of the materials were investigated and correlated with the CO₂ reduction performance. As shown in FIG. 3a, XRD patterns of Ga mixed with silver salts, which result in CO₂ conversion (i.e., AgF, AgCl, AgBr, AgI and AgOTf), show the presence of intermetallic Ag_{0.72}Ga_{0.28} crystal peaks. Ag₂Ga particles (generated from the sonication of Ga—Ag alloy directly from the two metals as shown in FIG. 17) and Ag particle inclusions (using Ga/AgNO₃ as the precursors, FIGS. 16a and d) are less efficient for CO₂ conversion. These results suggest that the formation of Ag_{0.72}Ga_{0.28} is a improves CO₂ reduction conversion efficiency due to the synergistic effect between gallium liquid metal and intermetallic phase. Surprisingly, the Ag_{0.72}Ga_{0.28} intermetallic phase crystals, generated from different silver salts, show distinct morphologies (as shown in FIG. 16e-i and FIG. 18) of spherical particles (FIG. 16e-g) or rods (FIG. 16i for AgF) or a combination of both (FIG. 16h for AgCl) together with the liquid metal Ga (spheres). The presence of rod-shaped morphology of the intermetallic phase (FIG. 16i for AgF) surprisingly improved the CO₂ catalytic capability of the catalyst described herein. The Ga/AgF catalyst, which generated the highest efficiency for CO₂ conversion was observed when the intermetallic phase Ag_{0.72}Ga_{0.28} was rod-shaped. While non-rod (i.e., spherical) intermetallic phase Ag_{0.72}Ga_{0.28} derived from other silver salts (or limited rod morphology for AgCl) exhibited lower catalytic efficiencies.

The high-resolution TEM images and SAED pattern (FIGS. 16j and k) and the TEM-based EDS mapping (FIG. 16l-n) further confirm the intermetallic phase Ag_{0.72}Ga_{0.28} rods and their growth direction along the [201] lattice plane (FIG. 16k). As shown in FIG. 16o-q, the native oxide layer on the surface of the liquid metal Ga droplets can be observed when dried for analysis. Furthermore, there were no obvious changes to the morphology of the intermetallic Ag_{0.72}Ga_{0.28} structures after 5 hours of reaction according to both XRD (FIG. 18x) and SEM (FIG. 19), indicating that the intermetallic phase Ag_{0.72}Ga_{0.28} rods were stable under mechanical agitation.

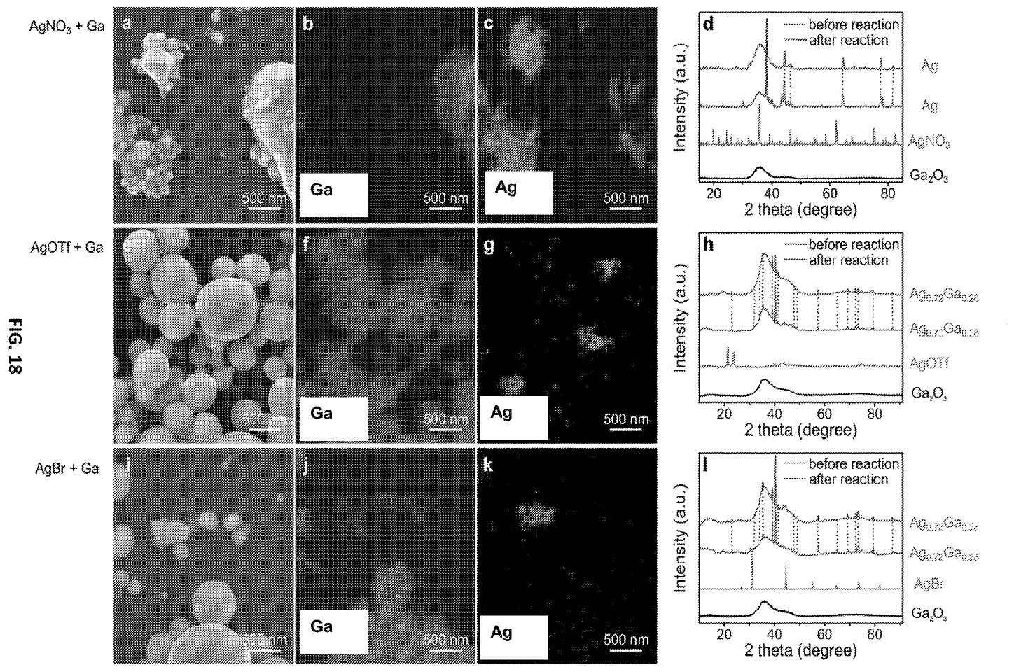

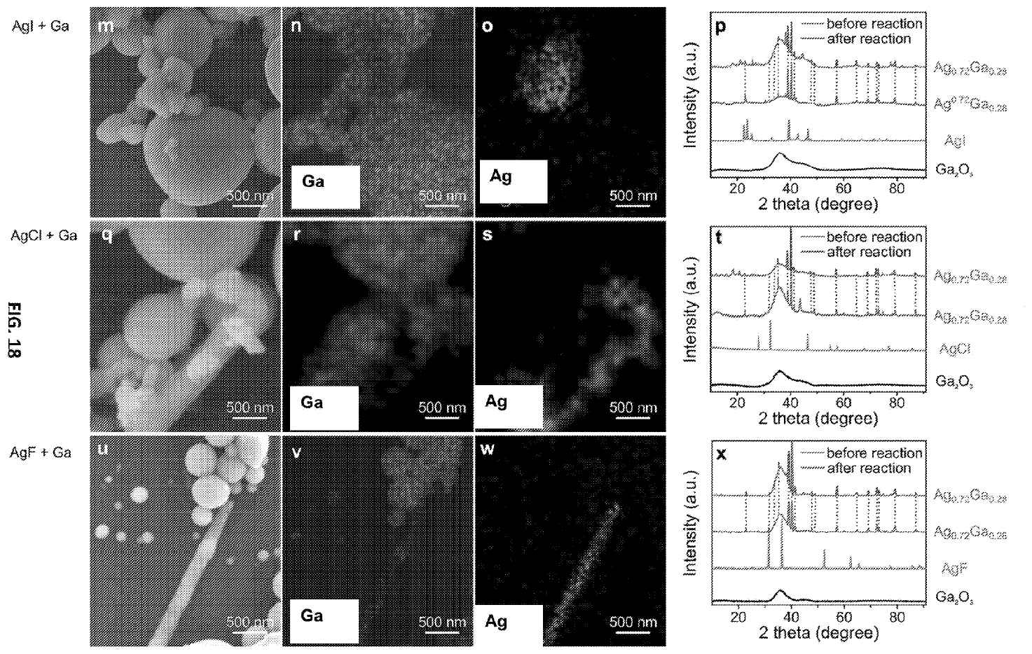

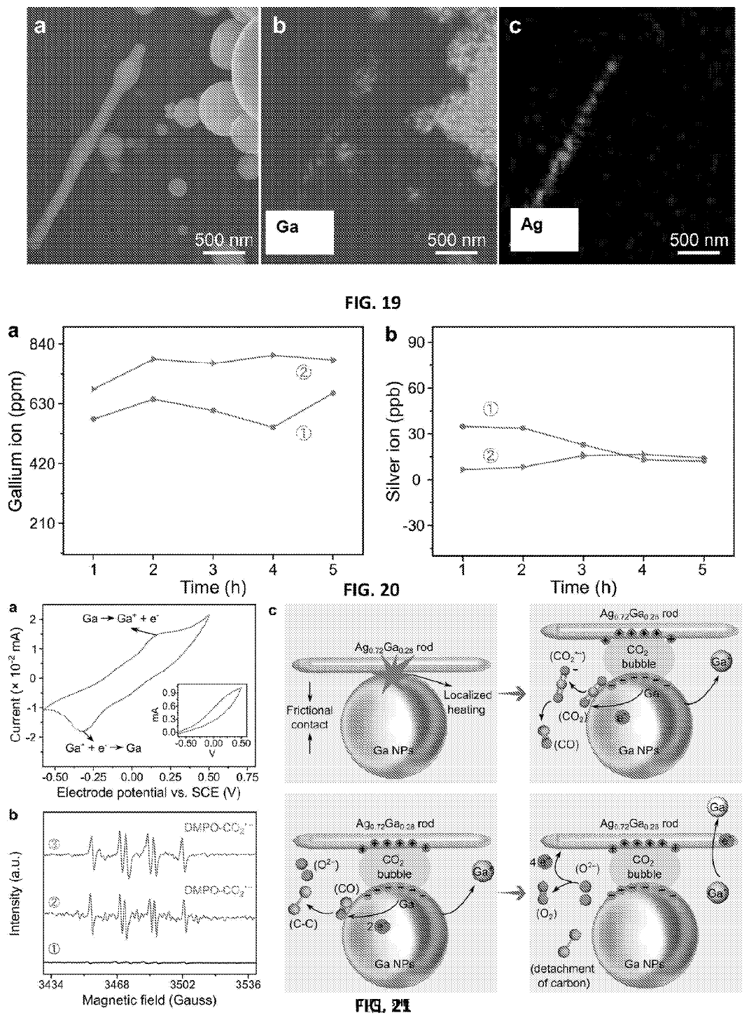

The concentration of gallium and silver ions in solution during the reaction were measured by inductively coupled plasma mass spectrometry (ICP-MS) (as shown in FIG. 20). The ion concentrations fluctuated without showing any increasing or decreasing trend, indicating that the catalysts are not consumed, and that the catalyst system is stable.

### Example 9: Reaction Mechanism

Without being bound by any one theory, the present inventors believe that the mechanism of the catalyst of Example 5 may be a result of the following: The contact of the Ga/DMF (liquid metal-solvent) interface is altered by the interfacial formation of CO₂ bubbles. CO₂ bubbles are formed as the Ga/DMF interface becomes warmer due to localised friction. As such, the interfacial solubility of CO₂ in DMF decreases. The formation of bubbles induces a significant increase in the transient, capacitive, open circuit voltage through triboelectrification between the separated Ga conductive liquid metal and the DMF dielectric. The formation of a “closed” loop, by the presence of intermetallic phase Ag_{0.72}Ga_{0.28} (such as in rod form), can then assist in the initiation of the CO₂ conversion process.

The CO₂ reduction in Example 5 is completed through a reversible Ga—Ga⁺ cycle (provided a closed loop allowing cycling between the two oxidation states of Ga(0) and Ga(I) without external stimuli or additives). Cyclic voltammetry was conducted to provide an insight into the catalytic mechanism of the intermetallic phase Ag_{0.72}Ga_{0.28}. Cyclic voltammetry results showed that, for the working electrode containing Ga droplets and Ag_{0.72}Ga_{0.28} rods as the intermetallic phase, Ga was oxidised to Ga⁺ at 0.18 V and then reduced to elemental gallium at −0.31 V (FIG. 21a). As the triboelectric process generates time-dependent voltages of several volts, the carbonaceous sheets were rapidly produced on the surface of liquid metals. Ga⁺ reduction was not observed when either Ga droplets (Inset of FIG. 21a) or Ga droplets with non-rod morphology Ag_{0.72}Ga_{0.28} were used as the working electrode (FIG. 22), demonstrating that an intermetallic phase of Ag_{0.72}Ga_{0.28}, preferably in the shape of rods, had a synergistic effect at reducing CO₂.

The overall reaction process in DMF is described by chemical reaction equations (1-6). The equations are separated into ‘liquid metal components’ reactions (equations (1-4)) and ‘solid components’ reactions (equations (5,6)). For the description of the liquid metal component reactions, a series of characterisations were conducted. Nuclear magnetic resonance analysis showed that the solvent DMF was not involved in the reaction (FIG. 23a). The CO₂ reduction in this particular embodiment is due to the voltage provided by the nano triboelectrochemical process on the surface of Ga liquid droplets that turn Ga into Ga⁺, while CO₂ is activated into the CO₂^{⋅-} radical (equation (1)). The existence of the CO₂^{⋅-} radical during the reaction is demonstrated by electron paramagnetic resonance (EPR), which uses 5,5-dimethyl-1-pyrroline N-oxide (DMPO) as a radical trapping agent to form DMPO—CO₂^{⋅-} for spectroscopic analysis (FIG. 21b, see “EPR EXPERIMENTS”).

The CO₂ to CO₂^{⋅-} process is followed by the generation of the intermediates CO and O²⁻ radicals (equation (2)). The former is further converted to solid carbon materials on the liquid metal surface (equation (3) which is the optimum case and it can be altered according to the C to 0 ratio in the obtained solid carbon). The equations are as follows:

Ga+CO₂→Ga⁺+CO₂^{⋅-} (1)

CO₂^{⋅-}+Ga→CO+Ga⁺+O²⁻ (2)

CO+2Ga→C+2Ga⁺+O²⁻ (3)

2O²⁻→O₂+4e⁻ (4)

The description of the ‘solid components’ reactions is as follows. According to the cyclic voltammetry results, the oxidized Ga⁺ can be reduced to elemental Ga by receiving an electron from the Ag_{0.72}Ga_{0.28} and the Ag_{0.72}Ga_{0.28} turns into Ag_{0.72}Ga_{0.28}+(equation (5)). The catalytic cycle is closed by the electrons provided from the O²⁻ to O₂ process (equation (4)) to reduce Ag_{0.72}Ga_{0.28}⁺ back to Ag_{0.72}Ga_{0.28} (equation (6)), where the existence of O₂ can be confirmed through gas chromatography (FIG. 11 and Table 1).

4Ga⁺+4Ag_{0.72}Ga_{0.28}→4Ga+4Ag_{0.72}Ga_{0.28}⁺ (5)

4Ag_{0.72}Ga_{0.28}⁺+4e⁻→4Ag_{0.72}Ga_{0.28} (6)

The catalytic cycle of CO₂ reduction at the interface of Ga droplets is shown in FIG. 21c. This catalytic mechanism also aligns with the DMF+ETA solvent mixture, and by-products are produced due to the presence of ETA that promotes the process towards CO production according to equation (5) (FIG. 11 and FIG. 23b).

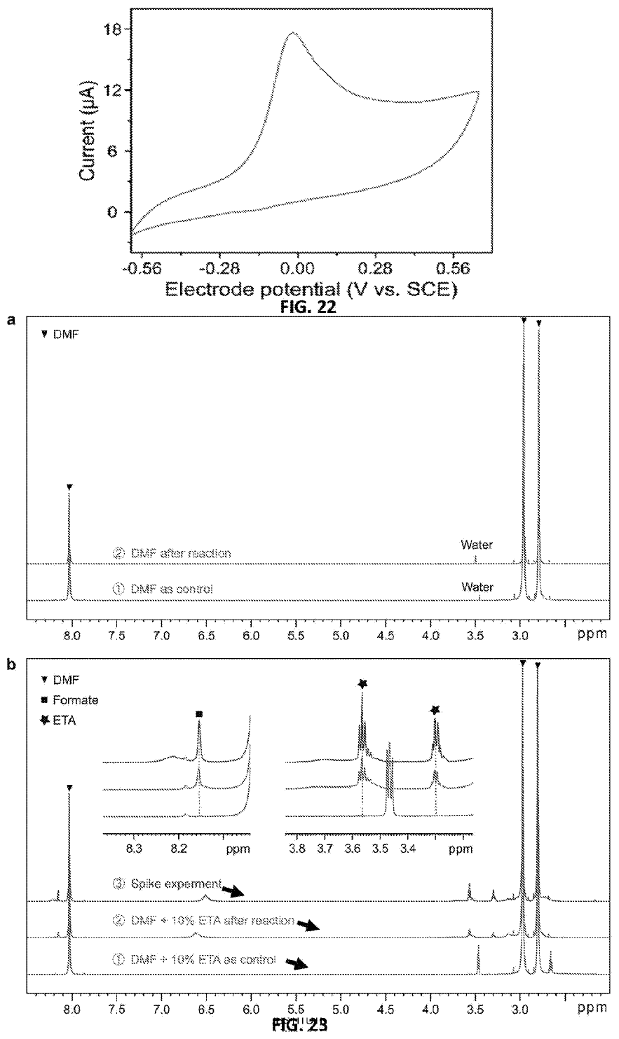

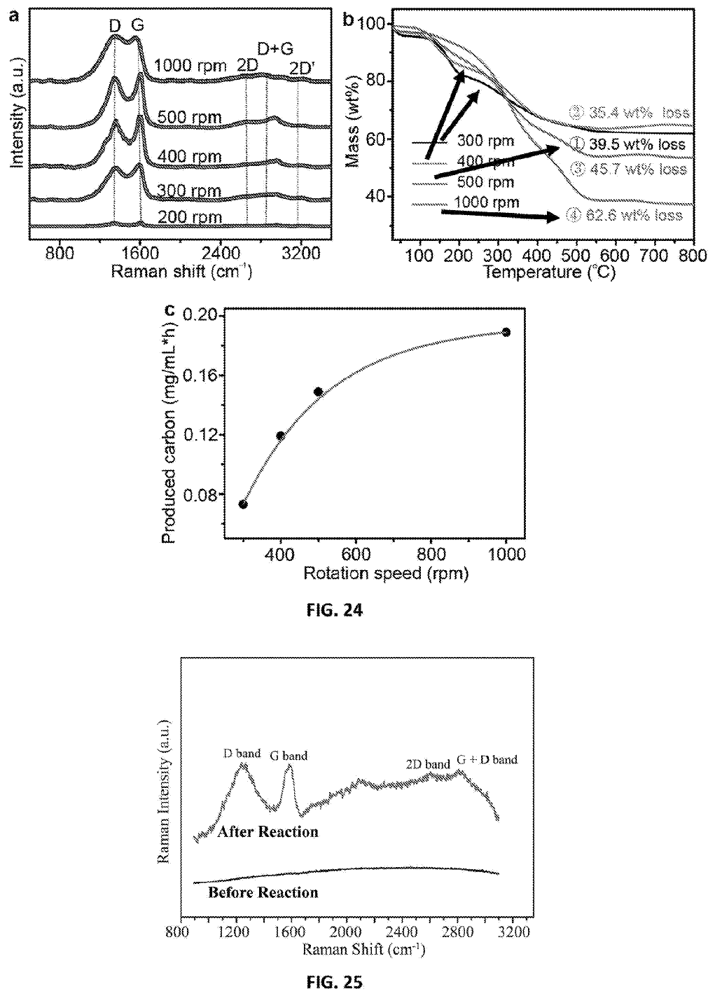

Since the reaction is activated by the triboelectric potential through application of energy such as sonication, other forms of mechanical stimuli can also be applied, and the system can be readily scaled up. As a demonstration, the present inventors further coupling an overhead stirrer to a 50 ml reactor. The present inventors found that CO₂ conversion continuously takes place in a stable manner when the stirring speed exceeds a threshold of 200 rpm (at room temperature, FIG. 24a) and the conversion efficiency increases along with the increase of the stirring speed (equivalently, the mechanical energy input) (Table 1 and FIGS. 24b and c).

In conclusion, we demonstrated a promising mechanical energy-induced CO₂ conversion method which operates solely with mechanical stimuli. The catalytic process was found to be mechanically enabled by co-contributors containing liquid metal Ga droplets and resilient intermetallic Ag_{0.72}Ga_{0.28} structures. We demonstrated the crucial roles of the composition and morphology of the functional materials, as well as the importance of precursor selection for triboelectrochemical CO₂ conversion. The obtained capture and conversion CO₂ efficiency was 92% for a reactor with a height as small as 27 cm at the input CO₂ flow rate of ˜8 sccm.

### Example 10: Calculation of Produced Carbon and Conversion Rate

Based on the TGA results for the catalyst of Example 5, the mass of the produced carbon materials is m_{TGA}×(δ−φ), where m_{TGA} and δ (%) are the mass of the collected sample before the TGA experiment and the mass loss ratio after the TGA test, respectively. The φ was the mass loss below 100° C. introduced to account for the loosely bound or adsorbed water and gas molecules in the sample. The total mass of the carbon materials produced (m_{c}) in the reactor (V₀, mL) per hour is:

$${m}_{C} = \frac{{V}_{0} \times {m}_{T G A} \times ( δ - φ )}{{V}_{T G A} \times T} \qquad ( S1 )$$

Where V₀ is the volume of the reactor, V_{TGA} (2 mL) is the volume of the sample collected for TGA and T (h) is the reaction time.

The CO₂ conversion rate (R) is defined as the volume ratio of the amount of captures and reduced CO₂ (Vᵣ) to that of the CO₂ bubbled (V_{b}) into the reactor per hour:

$$R = \frac{{V}_{r}}{{V}_{b}} \times 100 \% \qquad ( S2 )$$

where V_{b} is the flow rate of CO₂ bubbled into the reaction system (controlled at 10 sccm), which corresponds to 600 cm³ CO₂ gas input to the 20 mL reactor per hour. However, owing to the pressure and the viscosity of the solvent in the scaled-up experiments, the flow rate of CO₂ was ˜8.6 and ˜8.0 sccm in DMF and DMF+ETA cases. Vᵣ is calculated based on the GC results of the collected gas or the produced carbon products (solid carbon and carbon monoxide).

Two approaches were used to measure the volume of the captured and reduced gas, which correspond to two Vᵣ calculation methods:

(1) For the experiments conducted in the 20 mL small reactor, the amount of the reduced CO₂ was obtained from the products based on TGA and GC experiments:

$${V}_{r} = ( \frac{{M}_{C {O}_{2}}}{{M}_{C}} {m}_{C} ) / {d}_{{CO}_{2}} + {V}_{CO} \qquad ( S3 )$$

where M_{CO}_{₂} and M_{C} are the molecular weight of CO₂ and C, respectively, and d_{CO}_{₂} is the density of CO₂, which is taken as 0.00198 g/cm³.
(2) For the experiments conducted in the scaled-up reactors, Vᵣ was obtained directly from the amount of the output CO₂ gas (V_{out-CO}_{₂}) from GC experiments.

Vᵣ=V_{b}−V_{out-CO}_{₂} (S4)

### Example 11: Estimation of Energy Consumption

When the experiment was conducted in the 20 mL reactor, the energy consumption during CO₂ conversion process was roughly calculated by considering the power input from the bath sonicator (P₀, 20 W)², the size of the reactor (V₀, 20 cm³) and the liquid volume in the bath sonicator (VB, 2000 cm³) when the bath sonicator was employed as the energy source. Thus, the energy used for CO₂ conversion (P₁,W) is:

$${P}_{1} = {P}_{0} \times \frac{{V}_{0}}{{V}_{B}} \qquad ( S5 )$$

Further considering the size of the reactor being increased to 50 cm and 27 cm, respectively, the 45% or 100% of the bubbled CO₂ would be fully converted when DMF or DMF with 10% ETA were employed as the reaction solution. So, the energy consumption in both cases (Q_{DMF} and Q_{DMF+ETA}, kW·h) for converting 1.0 tonne (1×10⁶ g) of CO₂ was determined by equations (S4, S5):

$${Q}_{DMF} = {P}_{1} \times ( \frac{1 \times 1 {0}^{6}}{{d}_{{CO}_{2}} \times {V}_{r ( DMF )}} ) \qquad ( S6 )$$

$${Q}_{DMF + ETA} = {P}_{1} \times ( \frac{1 \times 1 {0}^{6}}{{d}_{{CO}_{2}} \times {V}_{r ( DMF + ETA )}} ) \qquad ( S7 )$$

### Example 12: The Triboelectrochemical Process

Under the assumption that the intermetallic phase, Ag_{0.72}Ga_{0.28}, in the form of rod morphology act as long nano conductors that close the electrical loop, in some embodiments, the open-circuit voltage Vₒ(t) between the liquid metal and the DMF at a distance of z(t) can be described by the following equation³:

$${V}_{o} ( t ) = - \frac{σ ( t ) z ( t )}{ε} \qquad ( S8 )$$

where σ(t) is the time-dependent charge density between Ga/DMF, ε=1.09ε₀ is the permittivity of CO₂ gas and ε₀=8.8×10⁻¹² F/m is the permittivity of vacuum. Initially, σ(0) can be taken as the charge density of the Ga/DMF EDL and z(0) as the EDL thickness.

As the CO₂ bubbles displace the Ga/DMF interface from z(0) to z(t), the charge density σ(t) decreases with time. This discharge process of the capacitive electric double layer (EDL) is essentially determined by the mobility of the charges (ions) in the electrolyte. Therefore, if the bubble/liquid metal interaction is comparable or faster than the discharge process (which is reasonable under high frequency mechanical agitation), equilibrium will not be reached. As a result, σ(0) discharges exponentially:

σ(t)=σ(0)e^{-t/t}^{_{R}} (S9)

and equation (S8) then becomes:

Vₒ(t)=−σ(0)z(t)e^{-t/t}^{_{R}}/ε (S10)

To calculate Vₒ(t), we assume that σ(0) is on the order of 1 μC/cm, which corresponds to the EDL thickness z(0); z(t) is equivalent to the size of the CO₂ bubbles which is comparable to that of the Ga nanoparticles ˜100 nm (for such small bubbles, can make this assumption); t is the same time scale as that of the mechanical agitation (sonication or stirring) and assume t_{R} is on the order of 10 μs. Equation (S10) then gives a rough estimation V₀(1/t)=−8 V at f=40 kHz sonication. Therefore, this transient potential rise is due to the insufficient discharge of the EDL capacitor as a result of the separation of the Ga/DMF interface, which shares similar working principles with triboelectric nanogenerators.

Despite its apparent high magnitude, this voltage Vₒ(t) alone cannot cause CO₂ conversion since the electric field intensity Vₒ(t)/z(t) drops during the process, in comparison to the EDL capacitor electric field intensity Vₒ(0)/z(0). The CO₂ conversion process takes place when the very long intermetallic phase Ag_{0.72}Ga_{0.28} rods close the electrochemical loop with the Ga droplets and the CO₂ bubbles. This nanoscale triboelectrochemical process can also explain why the sample with long Ag_{0.72}Ga_{0.28} rods shows improved performance compared to other Ag_{0.72}Ga_{0.28} structures.

### Example 13: Nmr Results

NMR tests (catalysts or catalytic systems of Examples 5 and 9) were performed to confirm that DMF and ETA only acted as a solvent and was not directly involved in the CO₂ conversion process. The NMR results showed that there were no significant changes in the ¹H spectra of DMF and ETA before and after reaction (FIG. 19a). When ETA is introduced into the reaction system, the hydrogen from HCl, water and amine group of ETA exchange with each other, resulting in a new chemical shift at 6.5 ppm. Furthermore, the protonated ethanolamine —CH₂ peaks shifted to 3.3 and 3.6 ppm, respectively (FIG. 19b). The amine group of ETA can impact CO₂ reduction process by generating formate as a by-product. A new peak was observed at 8.16 ppm, which was confirmed to be formate by the addition of a small amount of formic acid. However, compared with the production of solid carbon materials and CO, the quantity of produced formate was negligible.

### Example 14: Catalysts or Catalytic Systems for Co₂ Reduction

### Step A: Preparation of the Bulk Alloy

The Sn—Bi weight ratio used for preparing the alloy was set to 0.43:0.57 in this example (the preferred ratio can be varied from 1:4 to 4:1 however other weight ratios may be suitable as described herein); metallic bismuth and tin were placed in a glass container and melted by placing the container on a hot plate (300° C.), the heating was continued until the solid mixture was formed a liquid metal. During the first hour, the liquid metal was shaken gently to facilitate the mixing. The sample was then cooled to room temperature.

### Step B: Preparation of the Nano Alloy

The preparation was carried out with proper ventilation. One gram of the above alloy was immersed in 30 mL of glycerol in a glass vial. The glass vial was then placed in a preheated silicone oil bath (to heat the glycerol to above the melting point of the alloy). The immersed bulk metal usually melts within 30 minutes. Then, a probe sonicator coupled with a 6 mm diameter tip was used. The amplitude can be adjusted from 20%-40% to generate the desired size. The sonication can also be set with proper pulse if needed, e.g., 10 seconds on and 5 seconds off.

### Step C: CO₂ Reduction

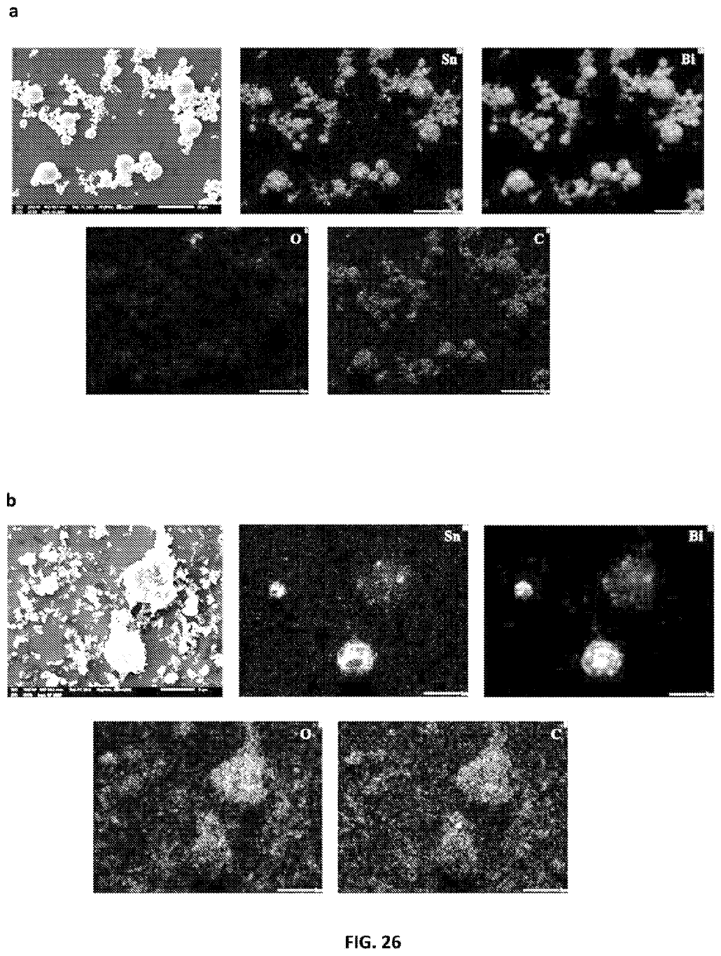

Following the preparation of nano alloy, the amplitude of the probe sonicator was adjusted to 20%; CO₂ was bubbled into the mixture throughout the reaction, the flow rate can be adjusted, e.g., 10-100 mL/min; After certain time (6 hours in this case), the mixture was cooled down to room temperature (CO₂ flow was maintained until the mixture reached ambient temperature). The mixture was then washed 5 times via centrifugation (to replace the viscous solvent with H₂O/Methanol/ethanol or other generally non-toxic and volatile solvent, it is not necessary but can assist with characterisation). The slurry was collected and re-suspended. If necessary, another low-speed centrifugation at 500 g for 1 min could be applied to remove large particles. The supernatant was collected and dried at 60° C. overnight. Raman spectroscopy was conducted as shown in FIG. 25. SEM images and elemental composition of the catalytic system before and after reaction are shown in FIG. 26 and Tables 2 and 3, respectively.

TABLE 2
Elemental mapping of a SnBi nanoalloy prior to reaction

| Element | Mass (%) | Atom (%) |
|---|---|---|
| C | 4.78 ± 0.02 | 31.23 ± 0.14 |
| O | 4.88 ± 0.08 | 23.94 ± 0.14 |
| Sn | 38.04 ± 0.14 | 25.17 ± 0.09 |
| Bi | 52.31 ± 0.16 | 19.66 ± 0.06 |
| Total | 100 | 100 |

TABLE 3
Elemental mapping of a SnBi nanoalloy after reaction

| Element | Mass (%) | Atom (%) |
|---|---|---|
| C | 29.83 ± 0.09 | 53.19 ± 0.16 |
| O | 30.97 ± 0.30 | 41.46 ± 0.40 |
| Sn | 17.03 ± 0.18 | 2.27 ± 0.02 |
| Bi | 22.18 ± 0.21 | 2.27 ± 0.02 |
| Total | 100 | 100 |

The Raman spectra shown in FIG. 25, shows that the carbon bands could be clearly seen on the post-reaction samples. While for the samples prior to the CO₂ reduction, the signal of carbon was negligible.

In the SEM images, stronger carbon signals could be visualized by the EDS (as shown in FIG. 26). The quantitative date also suggested that a significantly stronger carbon signal was observed after reaction compared to the samples before reaction.

### Example 15: Methane Reduction

The present inventors have also found that the catalysts or catalytic systems of the present invention can be used for converting methane into solid carbon and hydrogen gas. The inventors have found that incorporation of metallic salts (e.g. PtCl₄, and NiCl₂) into the liquid metal produced the functional materials which were efficient for methane conversion. In this embodiment, the weight ratio between the salts and Ga is 1:5. The method of making the materials by using PtCl₄ and Ga is similar to that of Example 1. As for NiCl₂, which cannot be reduced and alloys with Ga during the probe sonication process, 0.2 mL ethelyene glycol was added as the reductant for converting Ni²⁺ into elemental Ni.

Instead of CO₂, CH₄ is bubbled into the solvent. The catalytic product is solid carbon and hydrogen gas. The reaction conditions can be optimised by tunning the concentration of the materials, temperature and pressure.

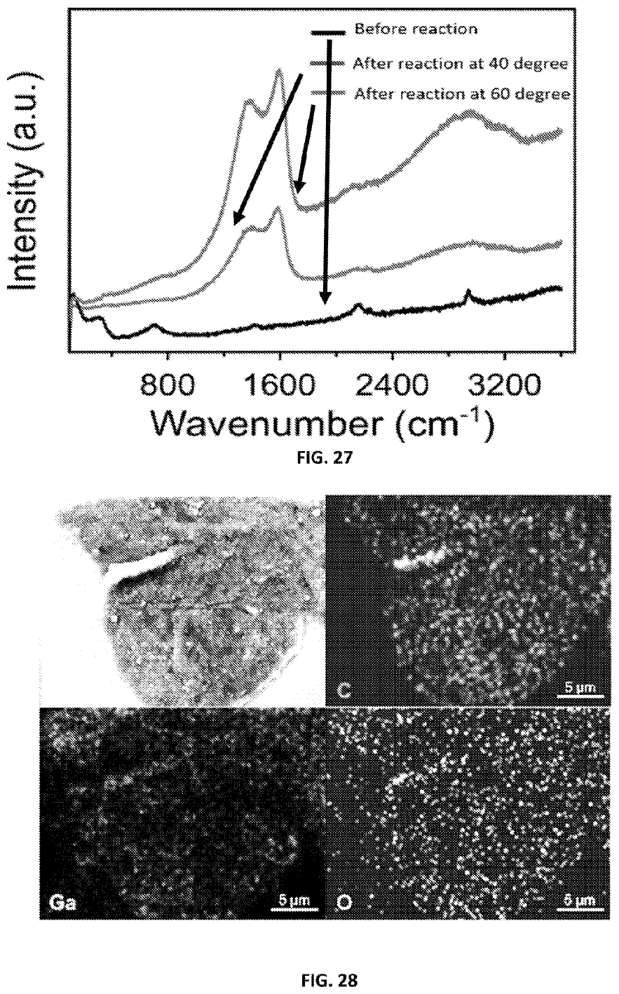

Raman spectra of carbon materials formed in the reaction system from methane reduction is shown in FIG. 27.

Owing to the density differences, carbon flakes accumulate on the top layer in the reaction system allowing separation of carbon and metallic materials. The SEM images and the elemental analysis of the carbonaceous materials are shown in FIG. 28.

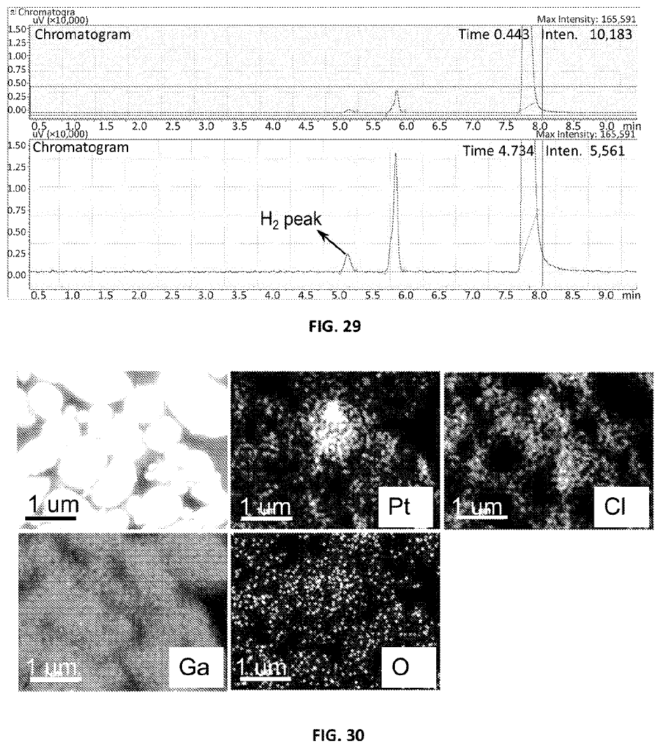

The output gas was also collected and analysed using Gas Chromatography (GC), and the existence of hydrogen gas was observed and shown in FIG. 29.

SEM microscopy image and EDS analysis of the materials produced from Ga/PtCl₄ catalytic system for methane conversion is shown in FIG. 30.

The size of the reactor in this embodiment used for CH₄ conversion was 20 mL. The efficiency of methane reduction can be improved by increasing the reactor dimensions and volume while increasing the pressure during catalysis.

1. A catalyst or catalytic system comprising liquid metal droplets dispersed in a solvent.

2. The catalyst or catalytic system of claim 1, wherein the liquid metal has a melting point of between 0° C. and 300° C.

3. The catalyst or catalytic system of claim 1, wherein the liquid metal comprises one or more metals selected from the group consisting of: mercury, gallium, indium, bismuth, lead, cadmium and tin.

4. The catalyst or catalytic system of claim 1, wherein the liquid metal further comprises a catalytic element selected from the group consisting of: silver, zinc, nickel, palladium, platinum, gold, silver, ruthenium, rhodium, iridium and cerium or a salt thereof.

5. The catalyst or catalytic system of claim 1, wherein the liquid metal comprises gallium, or an alloy of gallium indium and tin.

6. (canceled)

7. The catalyst or catalytic system of claim 1, wherein the liquid metal comprises eutectic alloys of low temperature melting point having a composition of with post transitional metals including gallium, indium, bismuth, lead, and tin.

8. The catalyst or catalytic system of claim 1, wherein the liquid metal comprises low-melting point metals of mercury or gallium, and from 30 to 0.1% of one or more further metals selected from the group consisting of: silver, nickel, palladium, platinum, gold, silver, ruthenium, rhodium, iridium and cerium or salts thereof.

9. The catalyst or catalytic system of claim 1, wherein the liquid metal comprises from 50 to 100% of a base alloy comprising two or more of gallium, indium, bismuth, lead, cadmium and tin, in combination with from 30 to 0.1% of one or more further metals selected from the group consisting of: silver, nickel, palladium, platinum, gold, silver, ruthenium, rhodium, iridium and cerium.

10. The catalyst or catalytic system of claim 1, wherein the liquid metal consists of an alloy of gallium and silver.

11. (canceled)

12. The catalyst or catalytic system of claim 1, wherein the liquid metal droplets have an average diameter of between 0.1 and 100 μm.

13. The catalyst or catalytic system of claim 1, wherein the catalyst or catalytic system further comprises a co-contributor.

14. The catalyst or catalytic system of claim 1, wherein the solvent has a boiling point of between 25° C. and 300° C.

15. (canceled)

16. The catalyst or catalytic system of claim 1, wherein the solvent is selected from the group consisting of dimethylformamide, acetonitrile and water.

17. The catalyst or catalytic system of claim 1, wherein the solvent has a carbon dioxide solubility of between 20 mg/L and 250 g/L at 25° C.

18. The catalyst or catalytic system of claim 1, wherein the solvent is acidified by addition of an acidifying agent which is an inorganic acid selected from the group consisting of: phosphoric acid, sulfuric acid, nitric acid, and hydrochloric acid, or a combination of two or more of these acids, or the solvent includes a basifying agent comprising a hydroxide or other basic substances.

19. (canceled)

20. The catalyst or catalytic system of claim 18, wherein the acidifying agent is present in the catalyst or catalytic system in an amount of between 0.01 M and 10 M.

21-22. (canceled)

23. The catalyst or catalytic system of claim 1, wherein the catalyst or catalytic system is for reduction of carbon dioxide to yield solid carbon and oxygen gas, or is for reduction of methane to yield solid carbon and hydrogen gas.

24. (canceled)

25. The catalyst or catalytic system of claim 1, wherein the liquid metal droplets are dispersed in the solvent by application of ultrasonic energy having a frequency of between 20 and 100 kHz.

26-38. (canceled)
